(19) United States
(12) Patent Application Publication
(10) Pub. No.: US 2026/0196540 A1
(43) Pub. Date: Jul. 9, 2026

(54) METHOD FOR RUNNING IN A FUEL CELL

(71) Applicant: SYMBIO FRANCE, Saint-Fons (FR)

(72) Inventors: Fabian Van Der Linden, Belfort (FR); Simon Morando, Mions (FR); Elodie Pahon, Belfort (FR); David Bouquain, Andelans (FR)

(21) Appl. No.: 19/123,983

(22) PCT Filed: Oct. 26, 2023
(86) PCT No.: PCT/EP2023/079900

§ 371 Date: Apr. 24, 2025

(30) Foreign Application Priority Data
Oct. 27, 2022 (FR) FR2211222

(51) Int. Cl. H01M 8/04223; H01M 8/04228; H01M 8/04537; H01M 8/04858; H01M 8/10; H01M 8/2483

(52) U.S. Cl. CPC H01M 8/04231; H01M 8/04228; H01M 8/04544; H01M 8/04895; H01M 8/2483; H01M 2008/1095

(57) ABSTRACT

The method for running in a fuel cell of the PEMFC type includes at least a first running-in phase, then an operation of reversing the direction of the hydrogen and air flows, then a second running-in phase. The running-in phases each includes a fuel cell stabilisation step in which the current density produced by the cell is kept constant at a low value for a given period, then an oxygen depletion step, during which the current density is kept constant at a minimum value, less than or equal to the low value, and during which the air supply is at least partially cut off, being adjusted so as to obtain a cathodic stoichiometric coefficient strictly less than 1. The oxygen depletion steps of the first and second run-in phases end when the cell voltage of the fuel cell reaches a predefined threshold voltage.

### FIELD

This invention relates to a method for running in a fuel cell.

### BACKGROUND

A fuel cell is a device for generating electricity by electrochemical reaction between a fuel, for example dihydrogen, and an oxidant, for example oxygen contained in the air. The focus here is on solid electrolyte proton exchange membrane fuel cells (PEMFCs), which usually comprise a stack of several individual cells, each of which constitutes an electrochemical generator.

Schematically, each unit cell comprises two separators, also known as polar plates, with a solid electrolyte in the form of a proton exchange membrane inserted between them. The membrane is made, for example, of a sulphonated perfluoropolymer material.

Within each cell, each separator delimits a reactive compartment with the corresponding membrane. One of the two compartments, known as the cathodic compartment, houses a cathode element formed by a cathodic catalytic layer on the surface of the membrane, while the other compartment, known as the anodic compartment, houses an anode element formed by an anode catalyst layer on the surface of the membrane. The assembly of the membrane and the anodic and cathodic catalytic layers forms a membrane-electrode assembly, generally referred to as a “MEA”.

For two neighbouring cells, a separator from one of the two cells is placed back to back with a separator from the other cell. These two separators together form a bipolar separator, also known as a bipolar plate. A cooling compartment, in which a cooling fluid such as glycolated water circulates, is generally arranged between the two separators of the bipolar separator.

Dihydrogen, air and coolant are the so-called “operating” fluids, which are supplied to the fuel cell during operation. Dihydrogen and air are reactants, while the coolant is not involved in the electrochemical reaction. Depending on the operating phases of the fuel cell, one or more of the operating fluids is supplied continuously or intermittently.

The fuel cell therefore has openings for supplying fluids to each of the reactive compartments and to the fluids between two adjacent cells. Thus, in a widely used design, each bipolar separator supplies fuel on one side to the cell adjacent to that side and combustive air on the other side to the cell adjacent to that other side, with the bipolar separators supplying fuel in parallel.

Generally speaking, in a unit cell, the cathodic compartment is supplied with oxidant, for example oxygen, most often in the form of a supply of oxygen-containing air, and the anodic compartment is supplied with fuel, for example dihydrogen.

Each reactive compartment also generally includes a gas diffusion layer, located between the bipolar separator and the catalytic layer, allowing good circulation of fuel or oxidant from the separator to the catalytic layer.

When the fuel cell is operating, the electrochemical reaction creates an electrical potential difference between the two separators in each unit cell. The fuel cell thus comprises an electrical insulation device, designed to prevent any electrical contact between two adjacent bipolar separators and between each cell and the external environment, as well as a sealing device to prevent leakage of the operating fluids, in particular to prevent the fluid circulating in one reactive compartment from contaminating an adjacent reactive compartment.

The difference in electrical potential between the two separators of each unit cell creates a voltage across each cell, referred to as the “cell voltage”. All the cells in the fuel cell are electrically connected together in series, so that the voltage delivered across the fuel cell terminals is equal to the sum of the cell voltage of all the individual cells.

A PEMFC fuel cell requires an activation procedure, or running-in procedure, when it is first used after manufacture and before it is put into service. This running-in procedure aims to increase and stabilise the performance of the fuel cell, by modifying the physico-chemical properties of the fuel cell's unit cells.

In particular, the main objectives of the running-in procedure are to ensure optimum hydration of the membrane, to desorb pollutants present in the anodic and cathodic catalytic layers, and to activate the anodic and cathodic catalytic layers, this activation corresponding to morphological changes within the membrane-electrode assembly, in particular a change in the porosity of the catalytic layers and cleaning of the catalytic layers.

Generally, the running-in procedure for a fuel cell takes place on an activation bench, where the fuel cell is connected to a load and supplied with reactants. The running-in method involves adapting the load and reactant flow rates so as to maintain a predetermined voltage or current profile. During the running-in period, the performance of the fuel cell gradually increases until it stabilises and reaches a stopping criterion for the activation procedure. When this is reached, the fuel cell is considered to have run in. The stopping criterion may be a certain level of performance achieved, particularly in terms of efficiency expressed, for example, as a function of the electrical energy delivered by the cell per unit mass of hydrogen consumed, or a stabilisation of performance between two measurements, or both. An existing stopping criterion simply consists of stopping the running-in process after a certain predetermined time. This type of criterion is the least precise of all. For example, the stopping criterion is defined as being a difference between the voltage at an instant t and the voltage at an instant t+1, at a given constant current density produced by the fuel cell, which must be less than a certain threshold.

Most often, such a running-in process consists of maintaining a constant voltage at the terminals of the fuel cell, or maintaining a constant current density produced by the fuel cell, for a predetermined period, and then measuring the voltage and current at the terminals of the fuel cell at the end of this period. This cycle is repeated until the stopping criterion is reached.

Such a running-in process is generally lengthy, lasting up to several hours, and consumes a significant quantity of hydrogen, in particular several kilograms of hydrogen for a fuel cell with a maximum output of 10 KW or more. These two drawbacks mean that the running-in protocol is very costly, which is a disadvantage when it comes to implementing it on an industrial scale. It is therefore desirable to reduce the duration of the running-in processes, without however reducing the performance gains or causing damage to the fuel cell.

### SUMMARY

Certain techniques are known to speed up the running-in protocol. One of these techniques, known as reducing air over-stoichiometry, consists of supplying the fuel cell with reactants with a connected load, then reducing the air supply flow rate so as to briefly operate the fuel cell with a reduced quantity of oxygen compared with nominal operating conditions, by operating the fuel cell with a cathodic stoichiometry coefficient that is always greater than 1, but for example between 1 and 1.5. During this phase of reducing air over-stoichiometry, the cathodic compartment of each unit cell contains, in addition to air which has a reduced oxygen content compared with nominal conditions, a certain amount of hydrogen, because the fuel cell will operate locally as a proton pump which leads to the formation of hydrogen at the cathode in the areas where there is a lack of oxygen. Preferably, during this over-stoichiometry reduction phase, the load is controlled so that, for each unit cell, the cell voltage is low. The low cell voltage and the presence of hydrogen in the cathodic catalytic layer create favourable conditions for the desorption of impurities and the reduction of pollutant oxides located on the cathodic catalytic layer, which is thus cleaned, tending to increase the truly active surface area of the cathodic catalytic layer. This technique shortens the running-in process.

However, this technique has the disadvantage of leading to inhomogeneous fuel cell performance, as the reduction in oxygen levels in the air is not uniform within the cathodic compartment of the unit cells. In fact, this reduction is more pronounced at the air outlet opening than at the air inlet opening. In addition, reducing the air over-stoichiometry, as practised in the prior art, generates fluctuations in the cell voltage, which causes damage to the fuel cell. These degradations can include dissolution of the platinum, and/or corrosion of the bipolar separator, and/or corrosion of the carbon which is generally one of the components of the catalytic layer, and/or degradation of the membrane due to the appearance of points of excess heat.

These disadvantages are specifically addressed by the invention, which proposes a new process for running in a fuel cell that is faster, does not damage the fuel cell and gives better fuel cell performance.

To this end, the invention relates to a process for running in a fuel cell, the fuel cell comprising a stack of cells, each cell comprising a proton exchange membrane arranged between two bipolar plates, each bipolar plate delimiting, in said cell, with the proton exchange membrane, a reactive compartment, each cell thus comprising a cathodic compartment in which a cathodic catalytic layer is arranged, and an anodic compartment, in which a cathodic catalytic layer is arranged, and an anodic compartment in which an anode catalytic layer is arranged.

The fuel cell comprises a dihydrogen inlet supplying the anodic compartment of each cell with dihydrogen, and a dihydrogen outlet discharging the dihydrogen from each cell. The fuel cell comprises an air inlet supplying air to the cathodic compartment of each cell, and an air outlet removing air from each cell.

According to the invention, the running-in process comprises at least, in this order, the following phases:
a first running-in phase, comprising at least, in this order, the following steps:
preferably, a fuel cell stabilisation step, during which the current density produced by the fuel cell is kept constant at a low value for a predetermined period of time, and
an oxygen depletion step of the fuel cell, during which the current density produced by the fuel cell is kept constant at a minimum value, which may be less than or equal to the low value, and during which the supply of air to the fuel cell via the air inlet is at least partially cut off so as to drive the fuel cell into the oxygen depletion step, in particular by being advantageously adjusted so as to obtain a cathodic stoichiometric coefficient strictly less than 1, preferably less than or equal to 0.9, the oxygen depletion step of the first running-in phase ending when the cell voltage of the fuel cell reaches a predefined threshold voltage,
an operation of reversing the direction of the flows of hydrogen and air, in which the inlet for hydrogen and the outlet for hydrogen are reversed and in which the inlet for air and the outlet for air are reversed, and
a second running-in phase, comprising at least, in this order, the following steps:
preferably, a fuel cell stabilisation step, during which the current density produced by the fuel cell is kept constant at a low value for a predetermined period of time, and
a step for depleting the fuel cell of oxygen, during which the current density produced by the fuel cell is kept constant at a minimum value, possibly lower than or equal to the low value of the second running-in phase, and during which the air supply to the fuel cell via the air inlet is at least partially cut off so as to reduce the current density produced by the fuel cell, in particular by advantageously being set so as to obtain a cathodic stoichiometric coefficient strictly less than 1, preferably less than or equal to 0.9, the oxygen depletion step of the second running-in phase ending when the cell voltage of the fuel cell reaches a predefined threshold voltage.

The steps of the first running-in phase are carried out until a first stop condition is reached, and the steps of the second running-in phase are carried out until a second stop condition is reached.

Thanks to the invention, the oxygen depletion steps of the first running-in phase and the second running-in phase enable the reduction and desorption of other impurities on the surface of the cathodic catalytic layer, which is thus further cleaned. These steps are also carried out without any appreciable degradation of the fuel cell, because the air supply is sufficiently reduced to avoid voltage fluctuations due to the progressive reduction of the cell voltage, for example because the cathodic stoichiometric coefficient is strictly less than 1, preferably less than or equal to 0.9. In addition, degradation is prevented by avoiding cathodic depletion at high currents. In addition, thanks to the operation of reversing the direction of the hydrogen and air flows between the two running-in phases, consistent fuel cell performance is achieved despite the oxygen depletion steps. Finally, preferably, by linking the stabilisation step and the oxygen depletion step during the running-in phases, the efficiency of the oxygen depletion steps is maximised, because the stabilisation steps make it possible to obtain stable and homogeneous conditions within the fuel cell, avoiding generating performance inhomogeneities during the oxygen depletion steps. In addition, the stabilisation steps of the first running-in phase and the second running-in phase advantageously make it possible to oxidise impurities on the surface of the cathodic catalytic layer, because the current density maintained at a low value means that the fuel cell operates with a high cell voltage, which favours the oxidation reactions of certain impurities, thus at least partially cleaning the cathodic catalytic layer.

According to advantageous but not mandatory aspects of the invention, the running-in process incorporates one or more of the following features, used in isolation or in any combination that is technically feasible:
The first running-in phase also comprises, prior to the oxygen depletion step, a fuel cell stabilisation step, during which the current density produced by the fuel cell is kept constant at a low value for a predetermined period, the low value of the first running-in phase being greater than the minimum value and/or the second running-in phase also comprises, prior to the oxygen depletion step, a fuel cell stabilisation step, during which the current density produced by the fuel cell is kept constant at a low value for a predetermined period, the low value of the second running-in phase being greater than or equal to the minimum value.

The minimum value of the first running-in phase and the minimum value of the second running-in phase are between 0.01 A/cm² and 0.3A/cm², preferably equal to 0.02 A/cm².

The low value of the first running-in phase and the low value of the second running-in phase are between 0.03 A/cm² and 0.5A/cm², preferably equal to 0.3A/cm².

During at least one of the said oxygen depletion steps, the air supply to the fuel cell via the air inlet is at least partially cut off by being adjusted so as to obtain a cathodic stoichiometric coefficient strictly less than 1, preferably less than or equal to 0.9.

The oxygen depletion steps of the first running-in phase and the second running-in phase end when the cell voltage of the fuel cell reaches a threshold voltage of between 0.1V and 0.4V, preferably equal to 0.2V.

During the oxygen depletion steps of the first running-in phase and the second running-in phase, the air supply to the fuel cell via the air inlet is completely cut off, so as to obtain a cathodic stoichiometric coefficient equal to 0. In some embodiments, the cathodic stoichiometric coefficient will be maintained equal to 0 throughout the oxygen depletion step of the first running-in phase and/or the second running-in phase.

During the oxygen depletion steps of the first running-in phase and the second running-in phase, the air supply to the fuel cell via the air inlet is controlled so that the cell voltage of the fuel cell decreases monotonically.

The first running-in phase also includes the following steps, in this order and carried out before the oxygen depletion step:
a current density increase step, during which the current density produced by the fuel cell is progressively increased from a low value to a high value, the low value being greater than or equal to the minimum value of the first running-in phase
a fuel cell hydration step, during which the current density produced by the fuel cell is kept constant at the high value of the first running-in phase for a predetermined period, so as to hydrate the proton exchange membrane, and
a current density drop step, during which the current density produced by the fuel cell is dropped from the high value of the first running-in phase to the low value of the first running-in phase,
and the second running-in phase also comprises the following steps, in this order and carried out before the stabilisation and oxygen depletion steps:
a current density increase step, during which the current density produced by the fuel cell is progressively increased from a low value to a high value of the second running-in phase, the low value of the second running-in phase being greater than or equal to the minimum value of the second running-in phase
a fuel cell hydration step, during which the current density produced by the fuel cell is kept constant at the high value of the second running-in phase for a predetermined period, so as to hydrate the proton exchange membrane, and
a current density drop step, during which the current density produced by the fuel cell is dropped from the high value of the second running-in phase to the low value of the second running-in phase.

The high value of the first running-in phase and the high value of the second running-in phase are between 1.5 A/cm² and 3A/cm², preferably equal to 1.9A/cm².

The steps of increasing current density, hydration, decreasing current density, stabilisation and oxygen depletion of the first running-in phase are carried out cyclically at least twice. In addition, the first stop condition is reached when:
the cell voltage of the fuel cell at the end of the hydration step of the last cycle of the first running-in phase differs from the cell voltage of the fuel cell at the end of the hydration step of the penultimate cycle of the first running-in phase by a value of between 1 mV and 10 mV, preferably equal to 5 mV, or
where appropriate, the cell voltage of the fuel cell at the end of the stabilisation step of the last cycle of the first running-in phase differs from the cell voltage of the fuel cell at the end of the stabilisation step of the penultimate cycle of the first running-in phase by a value of between 1 mV and 10 mV, preferably equal to 5 mV.

In addition, the steps of increasing the current density, hydration, decreasing the current density and, where appropriate, stabilisation and oxygen depletion of the second running-in phase are carried out cyclically at least twice, and the second stop condition is reached when:
the cell voltage of the fuel cell at the end of the hydration step of the last cycle of the second running-in phase differs from the cell voltage of the fuel cell at the end of the hydration step of the penultimate cycle of the second running-in phase by a value of between 1 mV and 10 mV, preferably equal to 5 mV, or
where appropriate, the cell voltage of the fuel cell at the end of the stabilisation step of the last cycle of the second running-in phase differs from the cell voltage of the fuel cell at the end of the stabilisation step of the penultimate cycle of the second running-in phase by a value of between 1 mV and 10 mV, preferably equal to 5 mV.

The running-in method also comprises an initialisation phase, carried out before the first running-in phase, during which the current density produced by the fuel cell is gradually increased from a zero value to the high value of the first running-in phase, and, preferably, the initialisation phase takes place over a period of between 15 minutes and 45 minutes, and even more preferably over a period equal to 24 minutes.

The running-in method also comprises a control phase, carried out after the second running-in phase, during which the current density produced by the fuel cell is maintained at a constant level for a predetermined period of time, preferably for a period of between 45 minutes and 75 minutes, more preferably for a period of time equal to 60 minutes.

During the first running-in phase and the second running-in phase, an anode stoichiometric coefficient of the fuel cell is equal to a nominal anodic stoichiometric coefficient of the fuel cell, preferably between 1.3 and 2, even more preferably equal to 1.5. In addition, during the steps of increasing current density, hydration, current density drop and, if appropriate, stabilisation of the first running-in phase and the second running-in phase, a cathodic stoichiometric coefficient of the fuel cell is greater than a nominal cathodic stoichiometric coefficient of the fuel cell, preferably greater than 2, more preferably equal to 2.3.

During the first running-in phase and during the second running-in phase, an electrical load of variable resistance is connected across the fuel cell, the electrical load imposing current production on the fuel cell.

### BRIEF DESCRIPTION OF THE DRAWINGS

The invention will be better understood and its other advantages will become more apparent in the light of the following description of an embodiment of a power supply module, a power supply system and an assembly method, in accordance with its principle, given by way of example only and with reference to the drawings in which:

FIG. 1 is an expanded perspective view of a stack of a few cells of a fuel cell in accordance with the invention.

FIG. 2 is a representative curve of a running-in process for a fuel cell, the process being in accordance with the invention.

FIG. 3 is a curve representing a running-in phase of the running-in process illustrated in FIG. 2.

FIG. 4 shows two curves (B, C) representative of a change in cell voltage of the fuel cell during a step of oxygen depletion of the phase illustrated in FIG. 3, under two distinct stoichiometric conditions, in comparison with (A) a curve representative of a change in fuel cell voltage during a step of reduction of air super-stoichiometry as proposed in the prior art.

FIG. 5 is a diagram illustrating the electrochemical reactions occurring in the fuel cell of FIG. 1 during oxygen depletion steps at the cathode, carried out during two running-in phases of the running-in process shown in FIG. 2, and illustrating an operation of reversing the direction of the hydrogen and air flows of the running-in process.

FIG. 6 is a graph obtained from an impedance spectroscopy of a membrane of a fuel cell conforming to the invention which has been run-in, or activated, using the running-in process of the invention.

FIG. 7 is a polarisation curve of a fuel cell according to the invention which has been run-in, or activated, using the running-in process of the invention.

FIG. 8 is a voltammogram centred on the high potential zone of a membrane of a fuel cell conforming to the invention which has been run-in, or activated, using the running-in process of the invention.

FIG. 9 is a voltammogram centred on the low potential zone of a membrane of a fuel cell conforming to the invention which has been run-in, or activated, using the running-in process of the invention.

### DETAILED DESCRIPTION

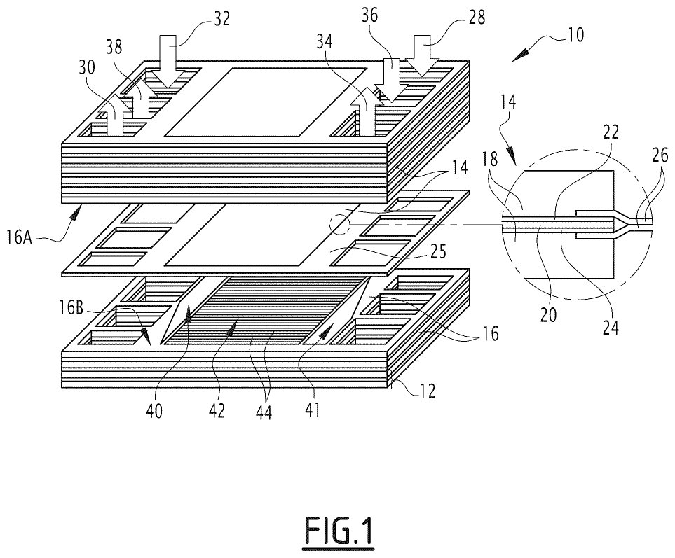

FIG. 1 illustrates a stack of cells 12 for a fuel cell 10. This fuel cell is designed, for example, to be installed in a vehicle and to produce electricity to power an electric motor to propel the vehicle.

The fuel cell 10 is of the proton exchange membrane fuel cell type and therefore comprises said stack of cells 12. This stack is held between two end plates, which are not shown in FIG. 1. In particular, these end plates make it possible to keep the stack of cells 12 compressed, i.e. tight, and to supply the stack with fuel, in the example gaseous dihydrogen, and oxidant, in the example gaseous air, and, if necessary, the circulation of a heat transfer fluid for a cell cooling circuit.

The invention will be described more particularly in the context of a common construction in which each cell 12 comprises a membrane-electrode assembly 14 and two bipolar plates 16, arranged on either side of the membrane-electrode assembly. However, the invention is also applicable to fuel cells of the solid electrolyte ion exchange membrane type with different constructions.

It is assumed that, for a given fuel cell 12, all the cells 12 in the fuel cell are identical to each other and therefore have identical characteristics.

FIG. 1 also shows a detail of a cross-section of the membrane-electrode assembly 14 of a cell 12.

In practice, each bipolar plate 16 is arranged between two cells 12 and is common to both cells. A first face 16A, referred to as the anode side, supplies one of the two cells with dihydrogen, and a second face 16B, referred to as the cathode side, supplies the other of the two cells with air. In other words, a cell 12 is supplied with dihydrogen by a first bipolar plate 16 and is supplied with air by a second bipolar plate. Air contains oxygen, so cell 12 is supplied with oxygen.

In the remainder of the description, the terms oxygen and dioxygen, as well as hydrogen and dihydrogen, are used interchangeably.

In the example, each bipolar plate 16 is formed by assembling two half-plates, this assembly forming hydrogen circulation channels on face 16A, air circulation channels on face 16B, and coolant circulation channels between faces 16A and 16B, i.e. inside the bipolar plate. The circulation of this coolant does not play any part in the electrochemical reactions of the fuel cell 10, but enables the temperature of the cells 12 to be controlled.

The membrane-electrode assembly 14 comprises two gas diffusion layers 18 arranged on either side of a proton exchange membrane 20, as well as an anodic catalytic layer 22, which is for example deposited on a first surface of the membrane, and a cathodic catalytic layer 24, which is for example deposited on the other surface of the membrane.

Thus, in the example, each cell 12 comprises, in this order, a bipolar plate 16 supplying the cell with dihydrogen, a gas diffusion layer 18, an anodic catalytic layer 22, a proton exchange membrane 20, a cathodic catalytic layer 24, a gas diffusion layer 18 and a bipolar plate 16 supplying the cell with air.

Each cell 12 has an anodic compartment, formed between the bipolar plate 16 supplying the cell with hydrogen and the membrane 20, and a cathodic compartment, formed between the bipolar plate 16 supplying the cell with air and the membrane. The anode catalyst layer 22 is arranged in the anodic compartment and the cathodic catalytic layer 24 is arranged in the cathodic compartment.

The gas diffusion layers 18, which are therefore each arranged in their respective anode or cathodic compartment, allow fuel and oxidant gases to be transported from the bipolar plates 16 to the anode 22 and cathode 24 catalytic layers. In practice, the gas diffusion layers are formed from a porous material, such as for example a non-woven textile of carbon fibres, i.e. a textile of carbon fibres whose fibres are randomly arranged, or a porous carbon paper, generally impregnated with a polymer, preferably a hydrophobic polymer, for example a fluoropolymer such as polytetrafluoroethylene (PTFE), in particular in order to make the surface of the fibres of the carbon paper more hydrophobic.

The proton exchange membrane 20 allows the passage of hydrogen ions, or protons, from the anodic compartment to the cathodic compartment 24, while preventing the circulation of gases and electrons between these two compartments. For example, it is made from a sulphurised perfluoropolymer material, such as a material known by the trade name Nafion.

When the fuel cell 10 is operating, within each cell 12, an oxidation reaction occurs in the anodic compartment, at the level of the anode catalytic layer 22. This oxidation reaction consists of catalytically splitting the dihydrogen supplied through the gas diffusion layer 18 into protons and electrons. The protons thus produced pass through the proton exchange membrane 20 until they reach the cathodic catalytic layer in the cathodic compartment, while the electrons are captured by the anode-side face 16A of the adjacent bipolar plate 16 and then conducted to the cathode-side face 16B of this same bipolar plate, this cathode-side face belonging to the cathodic compartment of the adjacent cell 12. At the same time, a reduction reaction occurs in the cathodic compartment of the cell 12, at the level of the cathodic catalytic layer 24. This reduction reaction consists of reacting the oxygen molecules supplied by the air, through the gas diffusion layer 18, with the protons passing through the membrane 20 and with the electrons supplied by the cathode side 16B of the bipolar plate 16, to form water molecules.

In practice, the catalytic layers 22 and 24 are porous structures formed from three different materials, namely:
A proton transport material, for example the same material as the proton exchange membrane 20, in this case Nafion.

A material to transport electrons, such as carbon.

A material for catalysing the electrochemical oxidation and reduction reactions described above, for example platinum. This material is present in the form of particles, preferably spherical, which are for example deposited on the surface of said material to transport electrons, for example the carbon mentioned above, during the manufacture of the catalytic layers.

In addition, the pores of the catalytic layers allow free transport of the reactants, i.e. hydrogen and oxygen, inside the catalytic layers.

Within the catalytic layers 22 and 24, there are regions where these three materials and the pores meet. These regions are called active sites, or triple points, and the electrochemical reactions take place at these active sites. Regions where not all the constituent elements of the catalytic layers are present, in particular zones where platinum is present but Nafion or carbon or access for the reactants is lacking, are called dead zones.

The catalytic layers 22 and 24 also contain impurities, or pollutants, which are, for example, residues or additives from the manufacture of the catalytic layers. In addition, the platinum particles contained in the catalyst layers generally have an oxide layer on their surface. When this layer of oxides becomes too thick, the platinum particles can no longer react with the protons and electrons and such a thick layer of oxides on the surface of the platinum particles can therefore be considered impurities.

In practice, the membrane-electrode assembly 14 of a cell 12 is arranged in an opening formed in a support plate 25, the support plate 25 being interposed between two bipolar plates 16. The support plate 25 can be made in the form of one or two layers of polymer film with a thickness of between 50 and 200 microns, for example. The polymer film is made, for example, of polyethylene terephthalate, also known as PET, or polyethylene naphthalate, also known as PEN. Advantageously, to ensure sealing between the membrane-electrode assembly and the bipolar plates 16 in the stack 12, the membrane-electrode assembly comprises two seals 26, located at the periphery of the membrane-electrode assembly, arranged between the gas diffusion layers 18 and the catalytic layers 22, 24, and extending as far as the support plate 25.

The fuel cell 10 comprises a dihydrogen inlet 28 supplying each cell with dihydrogen and a dihydrogen outlet 30 discharging the dihydrogen from each cell.

The fuel cell comprises an air inlet 32 supplying each cell with air and an air outlet 34 evacuating the air from each cell.

The air 34 and hydrogen 30 outlets also allow the water produced by the fuel cell to be evacuated.

The fuel cell comprises a coolant inlet 36 supplying each cell with coolant and a coolant outlet 38 discharging the coolant from each cell.

In the example, as shown in FIG. 1, the inlets 28, 32 and 26 and the outlets 30, 34 and 38 are formed by openings in the bipolar plates 16 and the support plates 25. In addition, these inlets and outlets are connected to openings in the end plates, which are in turn connected to hydrogen, air and refrigerant supply circuits, such as flexible or rigid piping. Alternatively, these inlets and outlets are formed by conduits arranged around the stack of cells and bipolar plates of the fuel cell.

As can be seen in FIG. 1, on its cathode-side face 16B, a bipolar plate 16 has two homogenisation zones 40, 41 and an active zone 42. A first homogenisation zone 40 connects the air inlet 32 to the active zone and a second homogenisation zone 41 connects the active zone to the air outlet 34.

The active zone 42 has channels 44 over its entire surface, which run right through the active zone, each connecting the homogenisation zone 40 to the homogenisation zone 41. The channels 44 thus enable the air flow to be conducted over the entire length of the cathodic compartment.

Here, the channels 44 are represented as being straight. In a variant not shown, the channels 44 have a different shape, for example a wavy, serpentine or broken line shape.

The homogenisation zones 40 and 41 connect the air inlets and outlets to the active zone 42 and enable the air to be distributed across the entire width of the active zone, to all the channels 44.

On the anode-side face 16A, a bipolar plate 16 has the same structure as on the cathode-side face 16B, namely two homogenisation zones and an active zone containing channels. On the anode side, the homogenisation zones connect the dihydrogen inlet and outlet to the active zone and enable the hydrogen to be distributed across the entire width of the active zone to all the channels.

In the example, the bipolar plates 16 and the support plates 25 are rectangular in shape. In the example, but not necessarily, and as can be seen in FIG. 1, the dihydrogen inlet 28 and the dihydrogen outlet 30 are located diagonally from one another, and the air inlet 32 and the air outlet 34 are also located diagonally from one another, which makes it possible to obtain a more homogeneous distribution of the reactive gases on the active zones 42 of the bipolar plates.

Preferably, each cell 12 of the fuel cell 10 has an active surface, corresponding to the surface of the active zone 42 of a bipolar plate 16, of between 150 cm² and 500 cm². Alternatively, this active surface can be smaller or larger.

For each of the anodic and cathodic compartments, a stoichiometric coefficient is defined as the ratio between the injected reactant flow rate and the minimum reactant flow rate of required to power the electrochemical reactions delivering the current density produced by the fuel cell required by the electrical load. Thus, for a stoichiometric coefficient of 1, the totality of the reactant, dihydrogen or oxygen from the air, supplied to an anodic or cathodic compartment, is consumed by the electrochemical reactions occurring at the level of the cathodic catalytic layer of this compartment. For a stoichiometric coefficient of 2, twice as much reactant is supplied as is needed.

The anodic and cathodic compartments can also have different stoichiometric coefficients.

A stoichiometric coefficient greater than 1 therefore does not lead to an increase in the current density produced by the fuel cell, but does lead to an increase in the amount of reactant consumed by the fuel cell, since the excess reactant supplied to the fuel cell, which is not consumed by the electrochemical reaction, is generally totally or partially lost. It should be noted, however, that a recirculation device is generally provided, at least for the hydrogen supplied to the anode, to limit the loss of hydrogen. When it comes to feeding the cathode, air recirculation is not always provided. In addition, a stoichiometric coefficient greater than 1, particularly in the cathodic compartment, results in a higher flow rate and therefore higher pressure losses, which has an impact on the performance of the fuel cell and the running-in process described below.

The anodic stoichiometric coefficient is the stoichiometric coefficient of the anodic compartment and the cathodic stoichiometric coefficient is the stoichiometric coefficient of the cathodic compartment.

In theory, anodic and cathodic stoichiometric coefficients equal to 1 are sufficient to power the fuel cell, assuming that diffusion of hydrogen and air within the anodic and cathodic compartments takes place instantaneously and without losses. However, in practice, when the fuel cell is used, for example in a vehicle, it is known to use anodic and cathodic stoichiometric coefficients greater than 1, i.e. to inject into the anode and cathodic compartments a flow rate of dihydrogen and air greater than the flow rate consumed, in order to guarantee a good supply to the fuel cell. This fuel cell operation is sometimes referred to as over-stoichiometric operation in the anodic and cathodic compartments. This over supply of reactants makes it possible, in particular, to take into account any leaks of dihydrogen and air in the fuel cell 10, and is particularly necessary to ensure correct operation of the fuel cell during transient phases of fuel cell operation, particularly when the current density produced by the fuel cell is increasing. In addition, without supercharging and given the transport time of the reactants through the gas diffusion layers 18 and inside the catalytic layers 22, 24, local shortages of reactants can be observed, leading to a reduction in the performance of the fuel cell. In this way, boosting the supply of reactants also ensures that there is always a sufficient supply of reactants in the catalyst layers.

In a manner known per se, nominal values of anodic and cathodic stoichiometric coefficients are also defined for each fuel cell, corresponding to a value of the anodic stoichiometric coefficient and a value of the cathodic stoichiometric coefficient used when the fuel cell is in normal operation, such as when the fuel cell is used in a vehicle. Typical nominal values for the fuel cell 10 are an anodic stoichiometric coefficient of 1.5 and a cathodic stoichiometric coefficient of 1.8, corresponding to over-stoichiometric operation.

Furthermore, the stoichiometric coefficients defined above are established theoretically, considering only the flow rates of reactants actually injected into the fuel cell and consumed by the electrochemical reactions. In fact, the supply circuits feeding the fuel cell with dihydrogen and air can leak and lose reactants. Thus, for a stoichiometric coefficient as defined above equal to 1, the actual flow rate of reactant delivered by the corresponding reactant feed circuit is slightly greater than the minimum flow rate of reactant necessary to feed the electrochemical reactions supplying the current density produced by the fuel cell required by the electrical load. An overall stoichiometric coefficient is then defined, which integrates the leaks and losses from the corresponding reactant feed circuit into the injected reactant flow rate. For example, for a stoichiometric coefficient as defined above equal to 1, the overall stoichiometric coefficient is equal to 1.1.

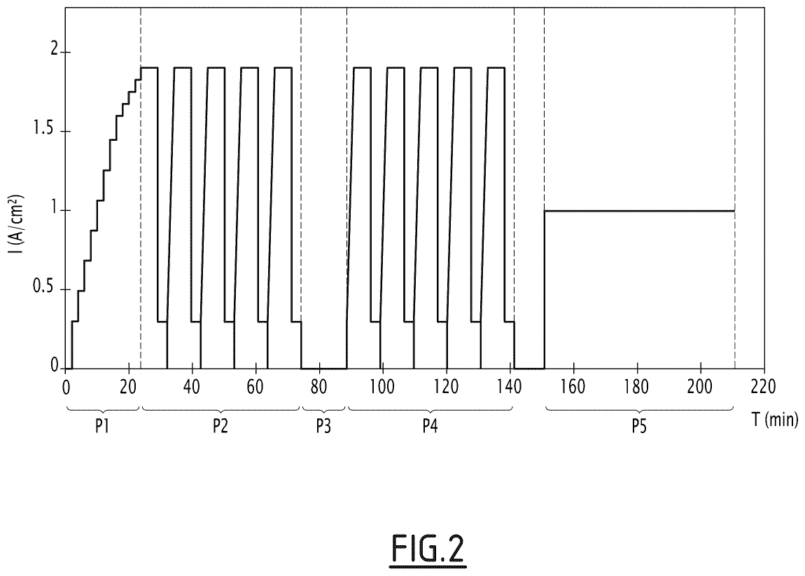

With reference to FIGS. 2 to 5, a running-in process for the fuel cell 10 is now described. This running-in process is intended to be carried out after the fuel cell 10 has been assembled and before it is put into service, and is designed to improve the performance of the fuel cell.

The three main objectives of this running-in process are:
an increase in the number of active sites in catalytic layers 22 and 24,
the desorption and removal of impurities present in and on the surface of the catalytic layers, and
hydration of the proton exchange membrane 20, leading to a reduction in the membrane's electrical resistance.

These objectives will increase the performance of the fuel cell. Among other things, each of these three main objectives makes it possible to increase the cell voltage delivered by each cell 12 of the fuel cell at the same current density produced by the fuel cell, thereby improving the performance of the fuel cell. For simplicity in this description, the cell voltage delivered by each fuel cell 12 is referred to as “fuel cell cell voltage” or “cell voltage”.

For example, it is possible to estimate the implementation of the running-in process described in this invention on a fuel cell by observing certain characteristics of the said cell. For example, the homogeneity of activation on the surface of the proton exchange membrane 20 can be analysed by sampling small sections of the said membrane located close to the air and/or dihydrogen inlet and outlet of a cell, several cells or even each cell. If the characteristics are identical for the sections of membrane analysed, then the activation is uniform between the inlet and the outlet, in particular between the air inlet and the air outlet, thus proving that the operation of reversing the direction of flow of the dihydrogen and air flows has been used for the running in of the said membrane.

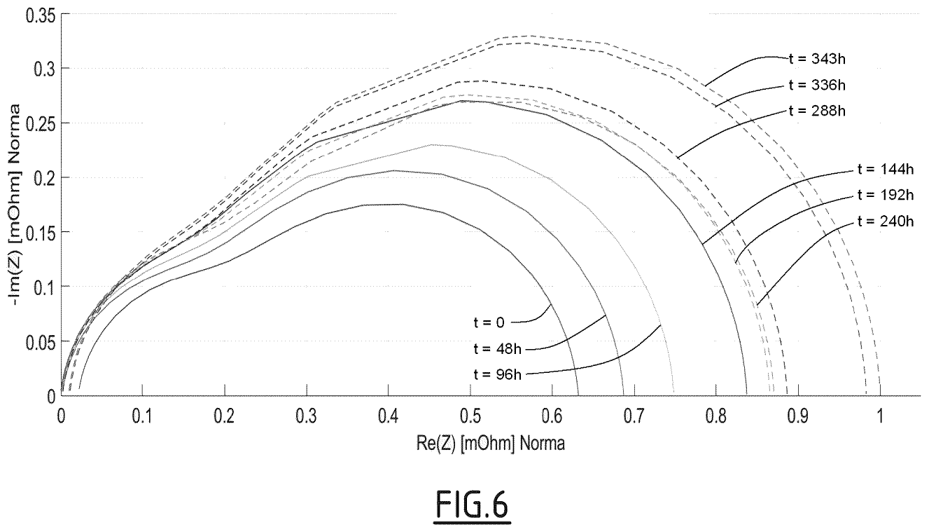

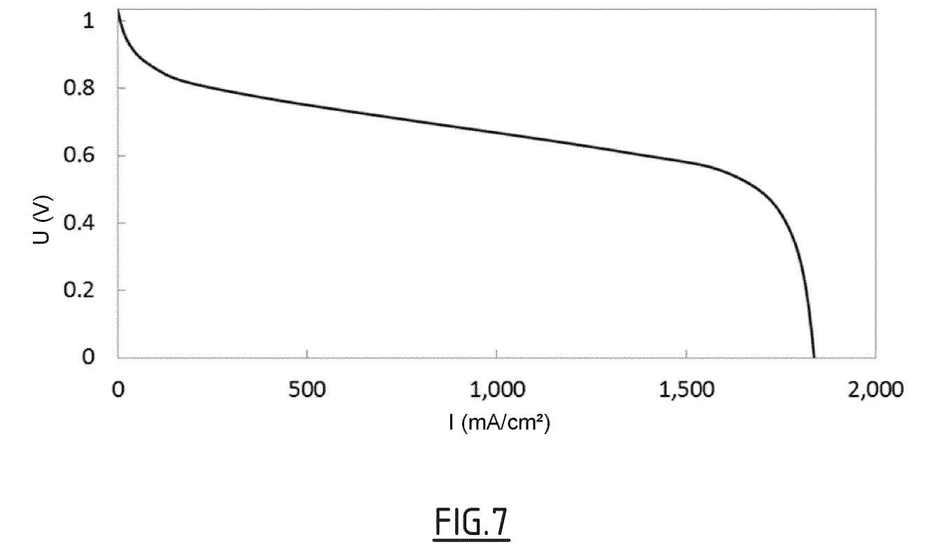

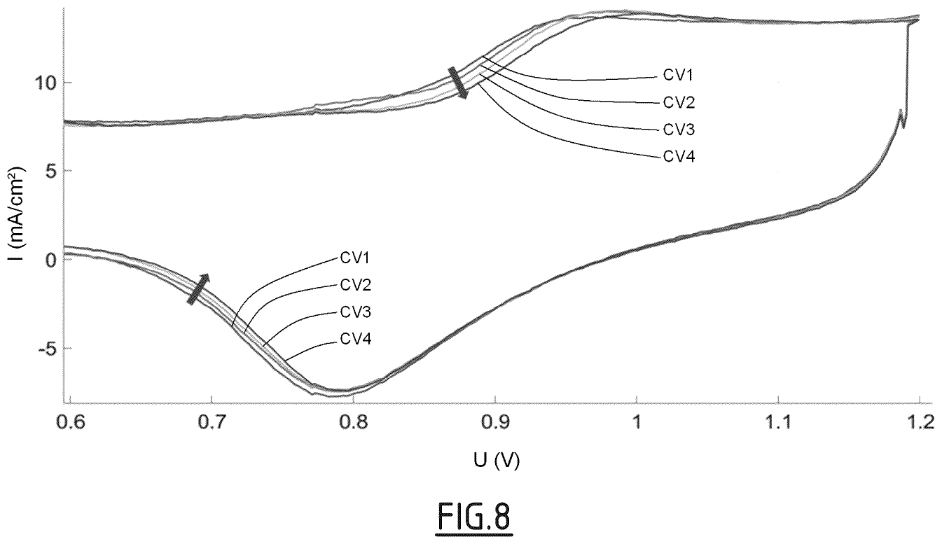

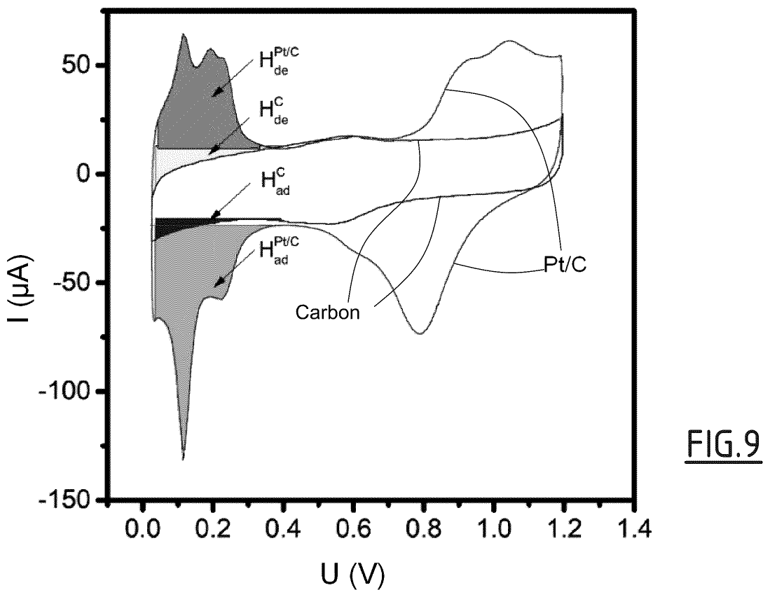

In particular, the following characteristics can be analysed:
Proton exchange membrane hydration rate: for example, the hydration rate of the proton exchange membrane can be measured using membrane impedance spectroscopy. An example of such a measurement is shown in FIG. 6, also known as a Nyquist diagram. This is a graphical representation of the real and imaginary parts of the battery impedance over a frequency range, in this case from 0.1 Hz to 10 kHz. Alternatively, or additionally, the hydration rate of the proton exchange membrane is obtained by analysing a polarisation curve of the cell. An example of a polarisation curve is shown in FIG. 7. This curve represents the average cell voltage of a fuel cell, as a function of the current density imposed on its terminals.
Impurity desorption evolution: for example, impurity desorption can be measured by cyclic voltammetry. An example of such a measurement is shown in FIG. 8. This curve represents the current response of a fuel cell when it is scanned for voltage. For example, to estimate the removal of impurities by the running-in process, the desorption of platinum oxide can be measured by cyclic voltammetry. This desorption of platinum oxide can be observed, for example, in the high potential area of the voltammogram, i.e. in the voltage range between 0.6V and 1.2V.
Evolution of porosity of the catalytic layer, this evolution can, for example, be determined by calculating the area of the hydrogen adsorption/desorption zone at low potential on a voltammogram carried out on the fuel cell, i.e. over the voltage range of the voltammogram between 0 and 0.4V. An example of such a voltammogram is shown in FIG. 9.

Advantageously, this running-in process can also be implemented on a fuel cell that has already been used, in order to eliminate certain reversible losses and thus partially compensate for the loss of performance associated with the ageing of the fuel cell.

During the running-in process, the fuel cell 10 is mounted on an activation bench, on which the fuel cell is connected to an electrical load and supplied with reactants, i.e. dihydrogen and air including oxygen, as well as a coolant. The electrical charge imposes a current that must be produced by the fuel cell. The voltage at the terminals of fuel cell 10 and the power delivered by the fuel cell, corresponding respectively to the voltage delivered to the electrical load and the electrical power consumed by the electrical load, are measured using non-representative sensors. The cell voltage of the fuel cell can then be deduced by dividing the terminal voltage of the fuel cell 10 by the number of cells 12 in the fuel cell.

In addition, the electrical load connected to the fuel cell 10 can be likened to a system combining a resistor with a power electronics converter, which is controllable so that current production is imposed on the fuel cell. In other words, the electrical load can be likened to a variable resistor that can be controlled so that the amount of current produced by the fuel cell can be chosen.

In a manner known per se, each fuel cell has a relationship between the voltage delivered at its terminals, hence the cell voltage delivered by each of its cells, and the current produced, so that, in the presence of a sufficient quantity of reactants, the voltage at the terminals of each cell, and therefore also the voltage at the terminals of the fuel cell, is a function of the current produced by the fuel cell, this function being dependent on the physico-chemical characteristics of the fuel cell. This function is typically represented by the polarisation curve of a fuel cell. So, for a given resistance of the controllable load, the current produced by the fuel cell is imposed, which makes it possible to determine the voltage at the fuel cell terminals, and therefore the cell voltage of the fuel cell, which depends on the characteristics of the fuel cell, and more particularly on the polarisation curve of the fuel cells.

It should also be noted that the current produced by the fuel cell 10 depends on the active surface of each cell 12, so that the current produced depends on the geometry of the fuel cell. Thus, in order to dispense with the geometric considerations of the fuel cell, reference is preferably made to the current density produced by the fuel cell, this current density being equal to the current produced by the fuel cell divided by the active surface area of each cell, and expressed in A/cm². In the present application, it is assumed that the current density is identical for all the cells 12 of the fuel cell, since they are electrically connected in series. Within a given cell, the current density is not necessarily homogeneous across the entire active surface of the cell. For a given cell, the current density we consider is therefore the average current density over the active surface of the cell. The application therefore refers to the current density produced by the fuel cell using the expression “current density”.

In the rest of the description, for the sake of brevity, the voltage at the terminals of the battery is assumed to be equal to the sum of the voltages at the terminals of each of the cells in the stack, and the voltage at the terminals of each of the cells, i.e. the cell voltage, is assumed to be identical for all the cells 12 in the stack. For each cell 12, the voltage at the terminals of the cell, i.e. the cell voltage, also corresponds to the difference between the electrical potential at the cathodic compartment, also referred to as the “cathodic potential”, and the electrical potential at the anodic compartment, also referred to as the “anodic potential”. In the cell assembly 12, it is assumed that a first cell in the stack has an absolute anodic potential of zero, i.e. equal to 0 V with respect to earth, while neglecting any abnormal anodic potential due to abnormal operating conditions at the anode, and which are not implemented in the context of the invention. At each subsequent cell, the absolute potential of each anodic compartment is therefore considered to be equal to the sum of the cell voltages of the previous cells in the stack. Consequently, as is usual in the field of fuel cells, the electrical potential of a cathodic compartment is defined, for a given cell, as a potential relative to the anodic potential of the cell in question. The cathodic potential of a given cell is therefore considered to be equal to the voltage at the terminals of this cell, and is expressed in Volts, disregarding any abnormal anodic potential for this cell, which would be due to abnormal operating conditions at the anode, which are not used in the context of the invention.

The improvement in the performance of the fuel cell 10 sought during the running-in process essentially consists of an increase in the cell voltage, for a given current density and for a given load resistance. In other words, this performance improvement consists of modifying the function linking voltage to current density, typically represented by the polarisation curve of the fuel cell cells. At the end of the running-in period, the cell voltage corresponding to a given current density is higher than the cell voltage corresponding to the same current density at the start of the running-in period. In other words, running-in causes the polarisation curve to “rise” over the entire current range of the fuel cell.

As shown in FIG. 2, the running-in process comprises five phases or operations, carried out in this order:
an initialisation phase P1, which is optional,
an initial running-in phase P2,
an operation for reversing the direction of the hydrogen and air flows P3, also referred to as the “reversal operation” in the remainder of the description,
a second running-in phase P4, and
an optional control phase P5.

FIG. 2 shows the evolution of the current density as a function of time throughout the running-in process.

At the start of the initialisation phase P1, the fuel cell 10 has not yet been put into operation. Its performance is then limited, and in particular, any rapid variation in current density would lead to damage to the fuel cell. In practice, a sudden increase in current density in a fuel cell that has just been assembled leads to a drop in cell voltage, resulting in the fuel cell overheating.

During the initialisation phase P1, the current density is gradually increased from zero to a high value. This high value is preferably between 1.5 A/cm² and 3A/cm², more preferably 1.9A/cm². In the example, the high value is equal to 1.9A/cm². The initialisation phase P1 is carried out over a long period, for example between 15 minutes and 45 minutes, preferably 24 minutes.

The initialisation phase P1 ensures that the fuel cell 10 starts up for the first time gradually and without damaging the cells 12.

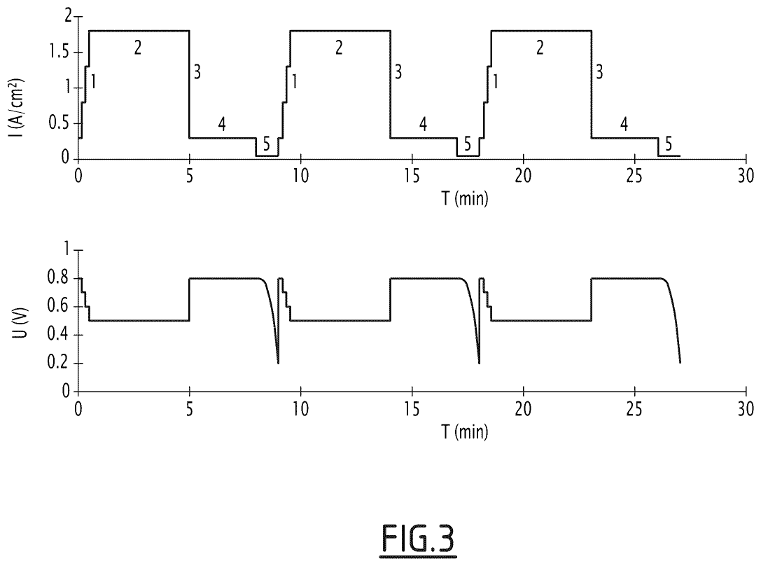

The first running-in phase P2 comprises a number of successive steps, carried out cyclically. Three cycles of the first running-in phase P2 are shown in detail in FIG. 3.

FIG. 3 shows, throughout the three cycles of the first running-in phase P2, the change in current density as a function of time on the upper curve and the change in cell voltage as a function of time on the lower curve.

It should be noted that the current density values shown in FIG. 3 are taken from representative values given by way of example, whereas the cell voltage values are indicative values, intended to present the cell voltage evolution profile, since these values vary in practice during the first running-in phase P2 and during the running-in process, as the performance of the fuel cell 10 is improved by the running-in protocol. The cell voltage is a result of the current density and efficiency of the fuel cell.

Each cycle of the first running-in phase P2 comprises five steps, performed in this order:
an optional current density increase step 1;
an optional hydration step 2;
an optional current density drop step 3;
an optional stabilisation step 4, and
an oxygen depletion step 5.

In the example shown in FIG. 2, the first running-in phase P2 comprises five cycles. In practice, the first running-in phase P2 ends when a first stop condition is reached, and may therefore comprise a number of cycles other than five. In particular, the first running-in phase P2 may comprise a single cycle.

The step of increasing the current density 1 consists of increasing the current density from a low value to the high value, which is preferably between 1.5 A/cm² and 3 A/cm², and in the example equal to 1.9A/cm². This increase in current density is achieved, for example, by controlling the electrical charge appropriately.

This increase is rapid, compared with the duration of the increase in the P1 initialisation phase. Preferably, this step is carried out over a period of between 2 seconds and 120 seconds, for example between 20 seconds and 60 seconds.

In practice, the duration of the current density increase step 1 is designed to be as short as possible without risking damage to the fuel cell 10. In practice, the duration of step 1 is long enough to avoid any sudden drop in voltage that could lead to overheating of the fuel cell and therefore damage to the cells 12. This time therefore depends on the performance and response time of the fuel cell. Advantageously, the duration of the current density increase step 1 is not constant from one cycle to the next, but is reduced as the performance of the fuel cell increases. The order of magnitude of this duration is a few tens of seconds to a few minutes. In the example shown in FIGS. 2 and 3, step 1 lasts 30 seconds.

It should be noted that the first cycle of the first running-in phase P2 is not representative of the other cycles of the first running-in phase, because the current density increase step 1 is not carried out there. At the end of the initialisation phase P1, the current density is already equal to the high value. In other words, for this first cycle, the initialisation phase P1 acts as the current density increase step 1.

The hydration step 2 consists of asking the fuel cell 10 to produce a high current density, equal to the high value, for a predetermined period of time. The high current density value is preferably chosen so as to create reducing conditions in the cathodic compartment. These reducing conditions are typically obtained when the cathodic potential of the cells is less than or equal to 0.5V (Volt). Thus, during this step, the battery charge is controlled so that the current density is high and, according to the law of relationship between the current density produced and the cell voltage at the terminals of a cell, the cathodic potential of the cells is relatively low, typically less than or equal to 0.5V. The duration of the hydration step 2 is preferably between 30 seconds and 10 minutes. In the example, hydration step 2 lasts 5 minutes.

The cathodic potential of the cells, during the hydration step, is said to be relatively low compared with the cathodic potential of the cells observed during normal operation of the fuel cell 10, during its use subsequent to its running-in, where the cathodic potential of the cells is generally between 0.6V and 0.7V.

Generally speaking, the anodic potential of the cells is assumed to be equal to OV and the cathodic potential of the cells is therefore approximately equal to the cell voltage.

The high current density results in significant water production in the cathodic compartment of cells 12, as the amount of electrochemical reactions occurring in the anodic 22 and cathodic 24 catalytic layers is proportional to the current density. This significant production of water leads to hydration of the proton exchange membrane 20, by contact between the water modules and the membrane.

Furthermore, from the second cycle onwards, this significant production of water enables the efficient removal from the cathodic compartment of the impurities desorbed during the oxygen depletion step 5 of the previous cycle, this step being described below. These impurities are transported by the water molecules formed in the cathodic catalytic layer and then evacuated through the gas diffusion layer 18.

In addition, from the second cycle onwards, this significant production of water also enables the hydrogen produced at the cathode during the oxygen depletion step to be removed from the cathodic compartment, this production of hydrogen at the cathode being described below.

The high current density also leads to a rise in the temperature of the cells 12 of the fuel cell. This current density and high temperature encourage an increase in the porosity of the catalytic layers 22 and 24, which increases the number of active sites of the catalytic layers.

Finally, during the hydration step 2, the cell voltage is relatively low, since the current density is high, so the electrical potential of the cathodic compartment of each cell 12 decreases. This potential is typically less than or equal to 0.5V. By way of comparison, the cathodic potential during the hydration step 2 is lower than the cathodic potential of the fuel cell when the fuel cell is in normal service, i.e. in operation, for example in a vehicle, which is typically in the range of 0.6 to 0.7V. This low potential makes it possible to obtain reduction conditions that enable certain impurities located in the cathodic catalytic layer 24, as well as platinum oxides, to be reduced. As a result of these reduction reactions, the impurities are desorbed and the platinum oxides are reduced to platinum particles on the one hand, and to desorbed impurities on the other. This increases the amount of non-oxidised platinum available in the cathodic catalytic layer, and therefore the number of active sites, while reducing the number of impurities in the cathodic catalytic layer. These reduced impurities are also evacuated from the anodic compartment by the water molecules.

The current density drop step 3 consists of rapidly lowering the current density from the high value to the low value. This drop in current density leads to an increase in cell voltage. This step is carried out as quickly as possible in order to optimise the duration of the running-in process, by rapidly reducing the current density required by the electrical load, as this rapid reduction in current density and rapid increase in cell voltage does not entail any risk of damaging the cells 12.

The low current density value is preferably between 0.03 A/cm² and 0.5A/cm², preferably even equal to 0.3A/cm², as in the example.

The stabilisation step 4 consists of asking the fuel cell 10 to produce a low current density, equal to the low value, for a predetermined period of time. During this step, since the current density is low, the cell voltage is relatively high.

The main aim of this step is to stabilise the operating conditions of the cell, i.e. to stabilise the temperature, humidity and pressure in the anodic and cathodic compartments, as well as the distribution of reactive gases within these compartments. It is therefore understood that this stabilisation step 4 is certainly preferential, but not obligatory, insofar as the operating conditions of the cell may already have been stabilised previously.

The stabilisation step 4 also makes it possible, thanks to the high cell voltage, to obtain conditions favourable to the oxidation of certain impurities in the cathodic catalytic layer 24, making it possible to desorb these impurities.

The stabilisation step 4 preferably lasts between 1 minute and 5 minutes. In the example, stabilisation step 4 lasts 3 minutes. In practice, this time depends essentially on the dimensions of the cells 12, and more particularly the membrane-electrode assemblies 14, as the larger the cell dimensions, the longer it takes to stabilise the operating conditions of the cell.

On the basis of the stable conditions obtained at the end of the stabilisation step 4, the oxygen depletion step 5 consists of requesting constant current production from the fuel cell 10, with a current density equal to a minimum value, then partially or completely shutting off the air supply to the fuel cell to obtain, in all cases, a cathodic stoichiometric coefficient strictly less than 1, preferably less than or equal to 0.9.

The minimum current density value is less than or equal to the low value.

Preferably, the minimum value is non-zero and less than or equal to 0.3A/cm². Even more preferably, the minimum value is between 0.01 A/cm² and 0.3A/cm². In the example, the minimum value is 0.02A/cm².

In practice, at the start of the oxygen depletion step 5, the air inlet 32 is adjusted so as to at least partially reduce the air supply, for example so as to obtain a cathodic stoichiometric coefficient strictly less than 1, preferably less than or equal to 0.9. Even more preferably, the air inlet 32 is adjusted so as to completely cut off the air supply, for example by means of a valve, so that as soon as the step starts, the air supply to the cathodic compartment is limited or even completely stopped. Throughout this step, the reduction reaction occurring at the level of the cathodic catalytic layer 24, which consumes oxygen to produce water molecules, therefore progressively consumes all the oxygen already present in the cathodic compartment at the time of closure of the air supply, and in cases where the air inlet 32 is adjusted so as to obtain a cathodic stoichiometric coefficient strictly less than 1 without being completely cut off, also consumes all the oxygen that continues to be supplied by the reduced air supply. This is because not enough oxygen is renewed in the cathodic compartment, since not enough air is renewed compared with the amount that would be necessary for the reaction, particularly when the cathodic stoichiometric coefficient is strictly less than 1, which implies that oxygen is consumed faster than it is renewed. The amount of oxygen in the cathodic compartment therefore decreases throughout the oxygen depletion step 5, which leads to a reduction in the number of electrochemical reactions occurring at the level of the cathodic catalytic layer 24. As a result of this reduction, the power that can be supplied by the fuel cell 10 gradually decreases, leading to a gradual drop in the cell voltage, since the current density is imposed by the electrical load, to a level equal to the minimum value. Thus, the complete or partial cut-off of the air supply to the fuel cell, as defined above, advantageously with a cathodic stoichiometric coefficient strictly less than 1, leads to a gradual reduction in the cell voltage.

Here, the cathodic stoichiometric coefficient considered does not correspond to the overall cathodic stoichiometric coefficient, i.e. it takes into account the air flow rate at the entrance to the cathodic compartment of each cell and actually consumed by the cell, i.e. without taking into account any leaks upstream of the cell, which could occur on the activation bench, for example.

An oxygen depletion step during which the cathodic stoichiometric coefficient is strictly less than 1 is further defined as a “global starvation” step.

In addition, the oxygen depletion step 5 can also be designed to progressively cut off the air supply until it is completely or partially cut off. On the other hand, if such a progressive cut-off of the air supply is implemented, then the oxygen depletion step 5 preferably starts with the air inlet 32 set so as to obtain a cathodic stoichiometric coefficient strictly less than 1, then, during step 5, the air inlet 32 is adjusted so as to progressively decrease the cathodic stoichiometric coefficient. Thus, even when the air supply is gradually cut off, the cathodic stoichiometric coefficient is strictly less than 1 at all times. Preferably, when passing from the stabilisation step 4 to the oxygen depletion step 5, the cathodic stoichiometric coefficient is changed from being very clearly greater than 1, for example greater than or equal to 1.8, or even greater than or equal to 2, to a cathodic stoichiometric coefficient strictly less than 1, preferably less than or equal to 0.9. This change in the cathodic stoichiometric coefficient takes place in steps, i.e. almost instantaneously in relation to the dynamics of the cell, i.e. in relation to its reaction to changes in the cathodic stoichiometric coefficient. In other words, the change in the cathodic stoichiometric coefficient is sudden rather than gradual. It should be noted that the cathodic stoichiometric coefficient, which is very clearly greater than 1, for example greater than or equal to 1.8, can be maintained constantly at this value during steps 1 to 4.

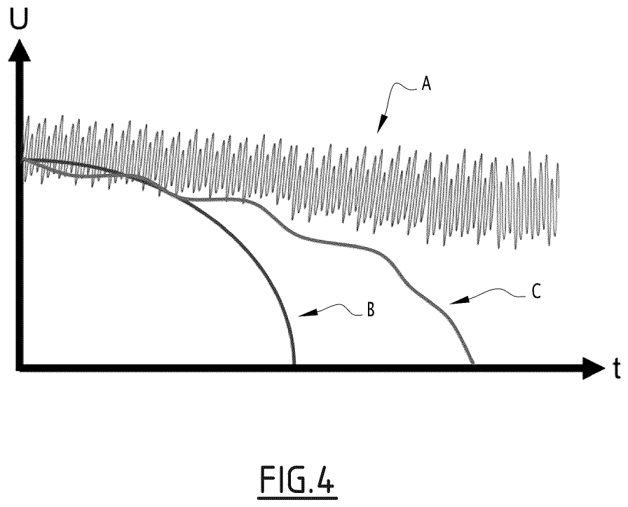

The progressive reduction in cell voltage during the oxygen depletion step 5 is best seen in FIG. 4, where it is represented schematically by curve B, for a complete cut-off of the air supply, i.e. for a cathodic stoichiometric coefficient equal to 0, or substantially equal to 0.

As can be seen from curve B in FIG. 4, during the oxygen depletion step 5, the cell voltage decreases monotonically, i.e. the cell voltage decreases continuously, without any increase, even of short duration or small amplitude. In addition, the rate of decrease of the cell voltage increases monotonically, i.e. the cell voltage decreases more and more rapidly as the oxygen depletion step progresses. This cell voltage profile is caused by the progressive reduction in the amount of oxygen available in the anodic compartment, which leads to an increasingly rapid drop in cell voltage.

FIG. 4 also shows, by means of curve A, the cell voltage profile that would occur in the event of reducing the air over-stoichiometry with a cathodic stoichiometric coefficient greater than or equal to 1 and less than the nominal cathodic coefficient, as achieved in known techniques for reducing air over-stoichiometry. Reducing the air over-stoichiometry therefore involves setting the cathodic stoichiometric coefficient at a value between the nominal cathodic stoichiometric coefficient and 1, and is achieved by reducing the air supply flow rate compared with the nominal flow rate. This reduction in air over-stoichiometry may also be referred to as a reduction in oxygen over-stoichiometry, or as a reduction in cathodic over-stoichiometry. As can be seen from curve A, such a reduction in the air supply, i.e. a reduction in air over-stoichiometry, leads to a gradual decrease in cell voltage, on average, but with significant fluctuations in this cell voltage. This fluctuation causes damage to the fuel cell, such as dissolution of the platinum, and/or corrosion of the bipolar separator, and/or corrosion of the carbon which is generally one of the components of the catalytic layer, and/or degradation of the membrane due to the appearance of points of excess heat.

In theory, if the air over-stoichiometry is reduced, the fuel cell has enough oxygen to produce the desired current density at a stable operating point, i.e. delivering a stable voltage at the fuel cell terminals, since the stoichiometric coefficient is greater than or equal to 1. This stable operating point would be determined, as a function of the desired current density production, by the polarisation curve of the fuel cells 12. However, in practice, when the cathodic stoichiometric coefficient is lower than the nominal cathodic stoichiometric coefficient, and a fortiori close to 1, local shortages of oxygen molecules are observed at the active sites of the cathodic catalytic layer. To reach the active sites, the oxygen molecules have to pass through the gas diffusion layer 18 and then penetrate the cathodic catalytic layer 24, which requires a certain amount of travel time. Thus, we observe that when a molecule of oxygen reaches an active site, it is immediately consumed in a reduction reaction, which generates a suction leading other molecules of oxygen towards the active site, but due to the absence of oxygen over-supply, these other oxygen molecules only reach the active site after a certain period of time, during which a lack of reactant is then observed, i.e. during this period no reduction reaction takes place at the active site. For each active site, there are alternating periods when reduction reactions occur, and periods when no reduction reaction takes place. At the level of a cell 12, and at the level of the fuel cell 10, this alternation leads to fluctuations in the cell voltage, as shown in curve A. In practice, choosing a nominal stoichiometric coefficient greater than 1, for example equal to 1.8, also helps to avoid these fluctuations, as the overabundance of oxygen ensures a permanent supply of oxygen to the active sites.

In addition, curve A shows a gradual decrease in cell voltage once the fluctuations have been averaged. This progressive decrease as the air over-stoichiometry is reduced is caused by reversible and/or irreversible degradation occurring in the fuel cell. These degradations are a consequence of cell voltage fluctuations, and are caused in particular by local lacks of hydration of the proton exchange membrane 20 of each cell 12, this lack of hydration itself being caused by repeated lacks of reduction reactions, locally at the active sites. In addition, as a result of the cell voltage fluctuations that occur, there is a fluctuation in the efficiency of fuel cell 10 and, consequently, a fluctuation in the temperature of the fuel cell. These fluctuations cause the fuel cell to deviate from its optimum operating parameters, which also leads to the observed degradation. It can also be seen that the average cell voltage observed on curve A tends to decrease and then stabilise at a value above OV. In practice, the closer the cathodic stoichiometric coefficient is to 1, being greater than 1, the more the average cell voltage observed on curve A, averaged over a time interval covering several fluctuations, tends to stabilise at an asymptotic value which decreases as the cathodic stoichiometric coefficient approaches 1 while remaining greater than 1, without however becoming zero. At the same time, the closer the cathodic stoichiometric coefficient is to 1, and greater than 1, the more the cell voltage will fluctuate, around this mean value, with an amplitude of fluctuation that increases as the cathodic stoichiometric coefficient approaches 1 and remains greater than 1. Finally, the closer the cathodic stoichiometric coefficient is to 1, by being greater than 1, the closer the minimum cell voltage observed when the A curve fluctuates tends to be to 0V.

It should be noted that this phenomenon of fluctuation is not observed on curve B, when the air supply is completely cut off, since no new molecules of dioxygen are supplied to the cathodic compartment, the suction generated at each active site is not capable of drawing new oxygen molecules towards the active site. On curve B, the cell voltage therefore decreases progressively as each active site consumes more oxygen molecules.

FIG. 4 also shows schematically by curve C the decrease in cell voltage observed in the case of a partial cut-off of the air supply, with a cathodic stoichiometric coefficient strictly between 0 and 1. In the example of curve C, the cathodic stoichiometric coefficient is 0.5. As a result of the partial cut in the air supply, a partial supply of air is maintained, but this is insufficient to maintain cell voltage. In practice, the oxygen molecules supplied by the air inlet 32 are consumed more and more quickly, as the oxygen present in the cathodic compartment at the start of step 5 is consumed. As a result, oxygen molecules are consumed by active sites closer and closer to the air inlet 32 and therefore have no chance of reaching active sites further away from the air inlet. For each cell 12, therefore, there is an increasingly large current-free zone. In practice, in the case of a partial cut in the air supply, the reduction in cell voltage takes longer than in the case of a total cut. In other words, the reduction in cell voltage is slowed down because the partial air supply is maintained. Fluctuations may also be observed, of lesser amplitude than those observed on curve A. As these fluctuations are less marked, their impact causes little or no damage to the fuel cell.

Thus, it is particularly advantageous to cut off the air supply entirely, or at least to cut it off partially to an extent sufficient for the cathodic stoichiometric coefficient to be strictly less than 1, preferably less than or equal to 0.9, as is done in the invention, in order to avoid or greatly limit cell voltage fluctuations and the associated damage. Thanks to the use, during the oxygen depletion step 5, of a cathodic stoichiometric coefficient strictly less than 1, preferably less than or equal to 0.9, and even more so in the event of a total air supply cut-off, damage to the fuel cell is prevented.

It should be noted that the curves in FIG. 4 illustrate trends in cell voltage when different cathodic stoichiometric coefficients are applied, but that these curves are not derived from real data and are therefore only provided to illustrate the phenomena described above. In particular, curves A, B and C in FIG. 4 do not represent actual cell voltage values.

The oxygen depletion step 5 ends as soon as the cell voltage reaches a predefined threshold voltage. In practice, this threshold voltage is between 0.1V and 0.4V. In the example, this threshold voltage is equal to 0.2V. This minimum voltage threshold is chosen to prevent damage to the cells 12 of the fuel cell 10. A cell voltage that is too low generally leads to cell damage, such as the formation of too much hydrogen peroxide, which is harmful to the cells 12. By choosing to stop the oxygen depletion step when this threshold voltage is reached, these degradations are avoided.

In practice, the duration of the oxygen depletion step 5 is between 1 and 120 seconds, preferably between 30 and 60 seconds. In the example, this time is approximately 45 seconds. What's more, this duration tends to vary from one cycle to the next.

In addition, the duration of the oxygen depletion step 5 depends in particular on the current density during this step. The higher the current density, the shorter the duration of the oxygen depletion step.

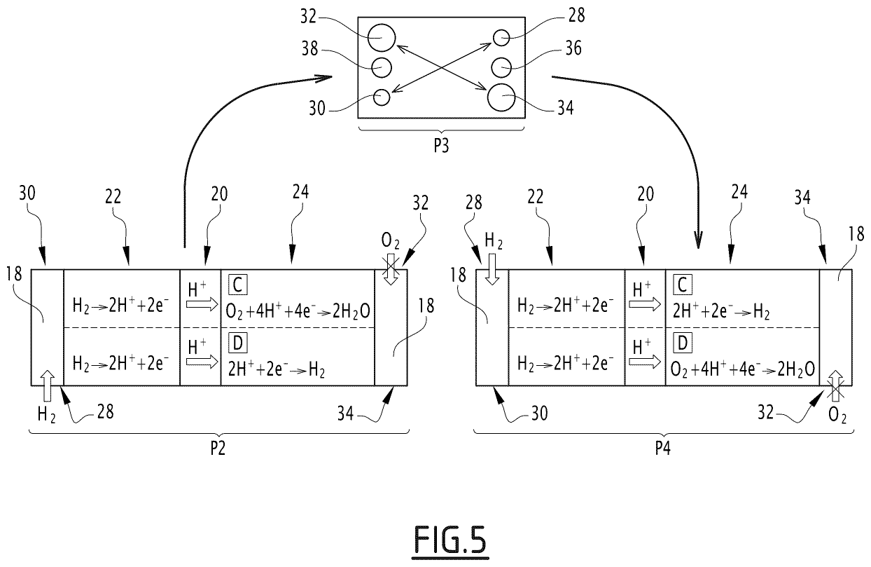

During the oxygen depletion step 5, as shown in FIG. 5, there is a gradient in the amount of oxygen available in the cathodic compartment, with more oxygen available at the air inlet 32 than at the air outlet 34.

In practice, during the oxygen depletion step 5, oxygen consumption is relatively homogeneous within the cathodic compartment, from the air inlet 32 to the air outlet 34. However, during normal operation of the fuel cell 10, with a stoichiometric coefficient strictly greater than 1, as for example during the stabilisation step 4, an oxygen concentration gradient is always observed, with a greater oxygen concentration at the air inlet than at the air outlet. This gradient is caused by the progressive consumption of oxygen by the electrochemical reactions occurring at the level of the cathodic catalytic layer 24 as the air progresses through the cathodic compartment, in the direction of air flow between the air inlet and the air outlet. In normal operation of the fuel cell, despite this oxygen concentration gradient, there is a sufficient quantity of oxygen to ensure the electrochemical reactions, including in the active zone closest to the air outlet, and this gradient therefore has no impact on the operation of the fuel cell. When the air supply is partially or completely cut off, at the start of the oxygen depletion step 5, the oxygen supplied is no longer sufficient to replace the oxygen consumed, and a decrease in oxygen concentration is observed. This decrease is thus relatively homogeneous within the cathodic compartment, but because of the oxygen concentration gradient observed before the start of the oxygen depletion step, the oxygen concentration will reach a zero value more quickly at the air outlet 34 than at the air inlet 32.

During the oxygen depletion step 5, therefore, there is a zero oxygen concentration near the air outlet 34 but a non-zero oxygen concentration near the air inlet 32.

Thus, in the half of the cathodic compartment closest to the air inlet 32, marked “C” in FIG. 5, normal reduction reactions occur, consuming the available oxygen to form water molecules.

On the other hand, in the half of the cathodic compartment closest to the air outlet 34, marked “D” in FIG. 5, i.e. where the oxygen concentration is lowest or zero, electrochemical reactions are observed, consuming the protons that have passed through the membrane 20 and the electrons coming from the cathode-side face 16B of the adjacent bipolar plate 16 to form dihydrogen molecules. This is because, due to the lack of oxygen molecules, the reduction reactions that normally occur in the cathodic compartment cannot take place, allowing electrons and protons to react together to form dihydrogen. This phenomenon is known as the “proton pump”.

The presence of dihydrogen in the cathodic compartment and the low cell voltage generate strong reducing conditions in the D half of the cathodic compartment, making it possible to reduce certain impurities located in the cathodic catalytic layer 24, in this half of the compartment, as well as platinum oxides. As a result of these reduction reactions, the impurities are desorbed and the platinum oxides reduced to platinum particles on the one hand, and to desorbed impurities on the other. This increases the amount of non-oxidised platinum available in the cathodic catalytic layer, and therefore the number of active sites, while reducing the number of impurities in the cathodic catalytic layer.

In practice, the reducing conditions obtained during the oxygen depletion step 5are stronger than the reducing conditions obtained during the hydration step 2, thus making it possible to desorb impurities from the cathodic catalytic layer more effectively, in particular, for this first running-in phase P2, in half D of the cathodic compartment. In particular, step 5 enables the desorption of impurities that cannot be desorbed during step 2 due to insufficiently strong reducing conditions. Most of these desorbed impurities are removed from the cathodic compartment during steps 1 and 2.

The oxygen depletion step 5 also hydrates the proton exchange membrane 20. Indeed, the absence of oxygen in the cathodic compartment, particularly in the half of the compartment closest to the air outlet 34, leads to an increase in the molecular fraction of water at the interface between the membrane and the cathodic catalytic layer, and the absence of air flow in the cathodic compartment leads to a lack of water evacuation. This increases the amount of water in the membrane, allowing it to hydrate. More precisely, when the oxygen contained in the air is consumed without being renewed, or by being renewed less quickly than it is consumed, then the molecular fraction of water becomes greater in the composition of the mixture of air and water present in the cathodic compartment.

In addition, the absence of an air supply, while the dihydrogen supply is maintained, leads to an increase in the difference between the pressure in the anodic compartment and the pressure in the cathodic compartment. This pressure difference causes new pores, or channels, to open in the anodic 22 and cathodic 24 catalyst layers, and existing pores to enlarge.

Advantageously, in order to further force the opening of pores in the anodic and cathodic catalyst layers, and in order to obtain stronger reducing conditions, it is possible to further increase the difference between the pressure prevailing in the anodic compartment and the pressure prevailing in the cathodic compartment, for example up to a value equal to 500 millibars, by adjusting the pressure set points of the test bench, i.e. by adjusting the dihydrogen pressure in the cathodic compartment. The hydrogen and air pressure can be controlled independently of the hydrogen and air flow rate, by controlling the hydrogen 28 and air 32 inlets and the hydrogen 30 and air 34 outlets.

The end of oxygen depletion step 5 marks the end of a cycle in the first running-in phase P2.

At the end of a cycle in the first running-in phase P2, it is checked whether a first stop condition has been reached. If this is the case, the first running-in phase P2 ends and the running-in process continues with the reversing operation P3.

If this is not the case, the first running-in phase P2 continues with a new cycle, again carrying out steps 1 to 5. The air supply to fuel cell 10 is then restored, which ends the oxygen depletion step and enables a new cycle to be started. In addition, and as can be seen in FIG. 3, when a new cycle of the first running-in phase P2 is to be carried out, then the oxygen depletion step 5 comprises an increase in the current density from the minimum value to the low value. This increase in current density coincides with the restoration of the air supply and occurs just before the switch to the new cycle.

Preferably, the first stop condition is reached when:
the cell voltage at the end of hydration step 2 of the current cycle differs from the cell voltage at the end of hydration step 2 of the previous cycle by a value of between 1 mV (millivolt) and 10 mV, preferably equal to 5 mV, or else preferably, when the first running-in phase P2 comprises the stabilisation step 4, the cell voltage at the end of the stabilisation step 4 of the current cycle differs from the cell voltage at the end of the stabilisation step 4 of the previous cycle by a value of between 1 mV and 10 mV, preferably equal to 5 mV.

This stop condition is therefore a cell voltage stability condition.

Advantageously, the first stop condition is carried out by comparing voltage measurements, namely cell voltage measurements or voltage measurements at the terminals of the fuel cell, at the end of the hydration step 2, rather than at the end of the stabilisation step 4, because the cell voltage measurement or the fuel cell terminal voltage measurement is more accurate when the current flow rate is greater. When the current flow rate is lower, the losses observed in the fuel cell 10 are more difficult to identify and result in a less accurate cell voltage measurement, or a less accurate measurement of the voltage at the fuel cell terminals. The cell voltage of a fuel cell can be measured by measuring the voltage across an individual cell, preferably by averaging the voltage measured across a number of cells, or by dividing the voltage at the fuel cell terminals by the number of cells in the fuel cell stack.

In practice, other conditions can be used. For example, a stop condition may correspond to reaching a minimum performance criterion, or it may be chosen as the completion of a certain number of predetermined cycles.

When a stop condition is not based on a comparison of performance between two consecutive cycles, it is therefore possible for the first running-in phase P2 to comprise a single cycle. It is also possible not to define a specific stop condition and to choose, prior to starting the running-in process, to execute only one cycle in the first running-in phase P2.

In the example shown in FIG. 2, the first stop condition is reached after five cycles of steps 1 to 5.

During the reversing operation P3, the electrical load is controlled so as not to require the fuel cell 10 to produce any current, and the fuel cell is not supplied with reactants, i.e. dihydrogen and oxygen. In other words, during this phase, the fuel cell is not operating. Thus, at the end of the last cycle of phase P2, the fuel cell is shut down as soon as the cell voltage reaches the predefined threshold voltage, although it is still possible, if necessary, to maintain a flow of coolant through the fuel cell in order to control its temperature.

The reversing operation P3 consists of inverting, i.e. swapping, on the one hand the dihydrogen inlet 28 and the dihydrogen outlet 30, and on the other hand the air inlet 32 and the air outlet 34. In other words, during the reversing operation P3, the direction of flow of the reactants in the fuel cell 10 is reversed. This reverses the direction of flow of the reactants in the channels 44 on the anode 16A and cathode 16B sides of the bipolar plates 16.

In practice, several methods can be used to reverse the inlets and outlets.

A first method is to manually disconnect the pipes connected to the hydrogen and air supply circuits and then reconnect these pipes by reversing the inlets and outlets. Preferably, when this method is used, a purge of the cells 12 of the fuel cell 10 is carried out before disconnection of the pipes with a neutral gas, preferably with nitrogen, so as to prevent any chemical reaction at the level of the catalytic layers 22 and 24, then a purge of the anodic compartments with dihydrogen and a purge of the cathodic compartments with oxygen is carried out before the fuel cell is restarted, in order to ensure that the fuel cell is correctly supplied with reactants.

Another method is to connect the inlets 28, 32 and outlets 30, 34 to the dihydrogen and air supply circuits using four-way valves, allowing the dihydrogen inlet 28 with the dihydrogen outlet 30 and to swap the air inlet 32 with the air outlet 34 without having to disconnect and reconnect the pipes. This method using a four-way valve is advantageous because it prevents any infiltration of gases other than reactive gases into the anodic and cathodic compartments. Furthermore, switching with a four-way valve eliminates the need to purge the circuits.

Once the reversing operation P3 has been carried out, the fuel cell 10 is restarted and the second running-in phase P4 begins.

The second running-in phase P4 comprises a number of successive steps, performed cyclically, which are preferably identical to the steps in the first running-in phase P2. Each cycle of the second running-in phase P4 therefore preferably comprises a current density increase step 1, a hydration step 2, a current density drop step 3, a stabilisation step 4 and an oxygen depletion step 5.

As these steps are identical to those in the first running-in phase P2, they are not described in further detail below.

Alternatively, the cycles of the second running-in phase P4 differ from the cycles of the first running-in phase P2 in that they do not comprise the same steps among steps 1 to 5. For example, each cycle of the first running-in phase P2 comprises steps 1, 2, 3, 4 and 5 and each cycle of the second running-in phase P4 comprises steps 1, 2, 3 and 5 and therefore does not comprise a stabilisation step 4. According to another example, each cycle of the first running-in phase P2 comprises steps 1, 2, 3 and 5 and therefore does not comprise a stabilisation step 4 and each cycle of the second running-in phase P4 comprises steps 1, 2, 3, 4 and 5. According to another example, each cycle of the first running-in phase P2 comprises steps 4 and 5 and each cycle of the second running-in phase P4 comprises only step 5 and therefore does not comprise a stabilisation step 4. According to another example, each cycle of the first running-in phase P2 comprises only step 5 and thus does not comprise a stabilisation step 4, and each cycle of the second running-in phase P4 comprises steps 4 and 5.

The second running-in phase P4 therefore provides the same advantages as the first running-in phase P2, i.e. it makes it possible, by alternating steps 1 to 5, to hydrate the membrane 20, to increase the number of active sites in the catalytic layers 22 and 24, in particular by modifying their porosity, to reduce, oxidise and desorb certain impurities, and to remove these impurities from the catalytic layers.

It is particularly advantageous to sequence the first running-in phase P2, the reversing operation P3 and the second running-in phase P4, as this sequence makes it possible to obtain uniform running-in over the entire surface of the membrane-electrode assemblies 14.

At the end of the first running-in phase P2, the cathodic catalytic layer 24 is not uniformly run in, since during the oxygen depletion steps 5 there is a gradient in the quantity of oxygen available between halves C and D of the cathodic compartment, leading to the appearance of reducing conditions only in half D of the cathodic compartment, as explained previously. The oxygen depletion steps 5 of the first running-in phase P2 therefore mainly enable impurities to be removed from the half D of the cathodic compartment.

However, since the second running-in phase P4 takes place after the reversing operation P3, it can be seen that the gradient in the quantity of available oxygen observed during the oxygen depletion steps 5 of the second running-in phase is reversed, compared with the available oxygen gradient observed during steps 5 of the first running-in phase P2.

In other words, the impurity desorption imbalance observed during the first running-in phase is also observed during the second running-in phase, but in reverse, i.e. during the first running-in phase, impurity desorption takes place mainly in a first physical half of the cathodic compartment, whereas during the second running-in phase, impurity desorption occurs mainly in the second physical half of the cathodic compartment.

Thus, during the second running-in phase P4, the oxygen depletion steps 5 mainly enable impurities to be desorbed from the half C of the cathodic compartment.

The sequence of phase P2, operation P3 and phase P4 therefore makes it possible to obtain uniform desorption of impurities over the entire surface of the cathodic catalytic layer 24, and therefore a uniform improvement in the performance of the membrane-electrode assembly 14.

In addition, this sequence is also particularly advantageous for optimising the duration of the running-in protocol, by enabling a cell to be run in completely and homogeneously over the entire surface of the cathodic catalytic layer 24 more quickly than with known running-in protocols.

At the end of a cycle in the second running-in phase P4, it is checked whether a second stop condition has been reached. If this is the case, the second running-in phase P4 ends and, in some embodiments, the running-in process continues, for example with the control phase P5.

If this is not the case, the second running-in phase P4 continues with a new cycle again performing steps 1 to 5, with the same direction of flow of the reactive gases as during the first cycle of this second running-in phase P4. The air supply to fuel cell 10 is then restored, which ends the oxygen depletion step and enables a new cycle to be started.

Preferably, the second stop condition is reached when:
the cell voltage at the end of hydration step 2 of the current cycle differs from the cell voltage at the end of hydration step 2 of the previous cycle by a value of between 1 mV (millivolt) and 10 mV, preferably equal to 5 mV, or else
the cell voltage at the end of stabilisation step 4 of the current cycle differs from the cell voltage at the end of stabilisation step 4 of the previous cycle by a value of between 1mV and 10 mV, preferably equal to 5 mV.

This stop condition is therefore a cell voltage stability condition.

Advantageously, the second stop condition is carried out by comparing cell voltage measurements or voltage measurements at the terminals of the fuel cell, at the end of the hydration step 2, rather than at the end of the stabilisation step 4, because the cell voltage measurement or the voltage measurement at the terminals of the fuel cell is more accurate when the current flow is greater. When the current flow rate is lower, any losses observed in the fuel cell 10 are more difficult to identify and result in a less accurate cell voltage measurement or voltage measurement at the fuel cell terminals.

In practice, other conditions can be used. For example, a stop condition may correspond to reaching a minimum performance criterion, or it may be chosen as the completion of a certain number of predetermined cycles.

When a stop condition is not based on a comparison of performance between two consecutive cycles, it is therefore possible for the second running-in phase P4 to comprise a single cycle. It is also possible not to define a specific stop condition and to choose, prior to starting the running-in process, to execute only one cycle in the first running-in phase P2.

Preferably, as in the example, the second stop condition is identical to the first stop condition.

Preferably, as in the example, the second running-in phase P4 comprises the same number of cycles as the first running-in phase P2.

In the example shown in FIG. 2, the first stop condition is reached after five cycles of steps 1 to 5.

During the optional control phase P5, the electrical load imposes a constant current density on the fuel cell 10 for a predetermined period of time, and the evolution of the cell voltage is observed. This optional P5 control phase is used to check that the battery performance is fully stable. If it is observed that the cell voltage remains stable throughout the P5 control phase, then the correct execution of the running-in protocol is confirmed and the fuel cell is ready to be commissioned.

The duration of the optional P5 control phase is preferably between 45 minutes and 75 minutes. In the example, this is 60 minutes

The current density during control phase P5 is preferably between 0.3 A/cm² and 1.9A/cm². In the example, the current density is equal to 1 A/cm². In addition, in the example, the P5 control phase lasts 60 minutes. The duration of the control phase can be different. It is preferably longer than 10 minutes, for example between 10 and 100 minutes.

In addition, measuring the cell voltage during the test phase enables the performance gain of the fuel cell 10 provided by the running-in protocol to be measured.

By way of example, on a fuel cell formed by a stack of cells 12 with an effective surface area of each membrane-electrode assembly 14 equal to 250cm², the performance gain obtained by the running-in protocol on the cell voltage of the fuel cell is between 10% and 50%, for example equal to 30%, when the electrical load imposes a current density of 1 A/cm² on the fuel cell, for a total duration of the running-in protocol of between 20 minutes and 300 minutes. The performance gain is preferably measured by comparing the quantity of electrical energy produced by the fuel cell 10 per kilogram of dihydrogen consumed by the electrochemical reactions before and after the running-in protocol has been carried out, the electrical energy produced by the fuel cell being measured in Wh, for example.

In a manner known per se, it can be considered in practice that the current density delivered by the fuel cell is imposed and controlled by the electrical load connected to the terminals of the fuel cell 10, and therefore does not depend on the quantity of reactants supplied by the anodic and cathodic compartments, as long as this quantity is sufficient, as determined by Faraday's laws, to drive the electrochemical reactions occurring in the anodic and cathodic compartments occurring in the anodic 22 and cathodic 24 catalytic layers, i.e. as long as the flow rate of reactive gases supplied to the dihydrogen 28 and air 32 inlets is sufficient. In other words, a surplus of hydrogen and air does not lead to an increase in current density. Conversely, a lack of hydrogen and/or air, and therefore oxygen, leads to a drop in cell voltage, as in the example of the oxygen depletion step 5 in the first and second running-in phases P2 and P4.

In practice, Faraday's laws state that the current supplied by an electrochemical reaction is a direct measure of the speed of the electrochemical reaction, i.e. the molar rate of reactant consumed. Thus, the current supplied i by an electrochemical reaction is equal to:

i=n×F×v

Where i is the current in amperes, n is the number of electrons transferred by the electrochemical reaction, Fis Faraday's constant, approximately equal to 96,485 C/mol (coulombs per mole), and vis the rate of reaction, expressed in mol/s (moles per second), also known as the consumed mole rate, corresponding to the rate at which the reactants are consumed.

So, as long as a sufficient molar flow of reactants is ensured at the active sites, the reaction rate v, and therefore the molar flow rate of reactants consumed, depends on the current supplied by the electrochemical reactions taking place at the active sites, and does not vary if there is a surplus of reactants.

Advantageously, throughout the running-in phases P2 and P4, the anodic stoichiometric coefficient is constant and equal to the nominal anodic stoichiometric coefficient of the fuel cell 10, preferably between 1.3 and 1.5, and even more preferably equal to 1.5. This relatively low value limits the consumption of dihydrogen during the running-in process, thereby reducing the cost of carrying out the running-in process.

Advantageously, throughout the running-in phases P2 and P4, the cathodic stoichiometric coefficient is constant and greater than the nominal cathodic stoichiometric coefficient of the fuel cell 10, except during the oxygen depletion phases 5 when the cathodic stoichiometric coefficient is strictly less than 1, preferably less than 0.9, more preferably equal to 0. Preferably, throughout the running-in phases P2 and P4, except during the oxygen depletion phases 5, the cathodic stoichiometric coefficient is greater than 2, for a fuel cell with a humidity level of between 30% and 80% in the cathodic compartment. In the example, the cathodic stoichiometric coefficient is 2.3.

This relatively high cathodic stoichiometric coefficient reduces the duration of the running-in protocol. The high flow rate of oxygen, a fortiori air, in the cathodic compartment leads to greater gas flow in the pores of the cathodic catalytic layer, which enlarges the existing pores, or channels, and opens up new channels in the cathodic catalytic layer, thus increasing the number of active sites in the cathodic catalytic layer. This high flow rate also helps to remove impurities desorbed from the cathodic catalytic layer 24 throughout the running-in process. This removal of impurities is particularly effective during the hydration steps 2 of the running-in phases P2 and P4. In addition, this relatively high cathodic stoichiometric coefficient, which therefore imposes a relatively high flow rate at the cathode, makes it possible to improve the response time of the fuel cell, and thus to reduce the duration of the current density increase step 1 of the running-in phases P2 and P4.

Compared with known running-in processes, the invention's running-in process has a number of advantages.

Firstly, the running-in process is particularly effective in increasing the performance of fuel cell 10 without generating damage likely to reduce the life of the fuel cell. In particular, the alternation between oxygen depletion steps 5 and lower cell voltage steps, i.e. hydration steps 2, promotes the desorption of the impurities and pollutants present in the catalytic layers 22 and 24, by enabling a maximum number of impurities to be successively reduced and oxidised. The process also makes it possible to use all the means for improving the performance of the fuel cell 10, namely hydration of the proton exchange membrane 20, increasing the number of active sites in the catalytic layers and desorption and removal of the impurities and pollutants present in and on the surface of the catalytic layers. Damage to the fuel cell is prevented in particular by the stabilisation steps 4, which allow the hydration 2 and oxygen depletion 5 steps to be followed without generating negative operating conditions for the fuel cell, and by the total or partial cut-off of air, and therefore of oxygen, as defined above, carried out during the oxygen depletion steps, making it possible to avoid cell voltage fluctuations that are harmful to the fuel cell.

Next, the running-in process makes it possible to achieve homogeneous performance over the entire surface of the membrane-electrode assemblies 14, in particular thanks to the reversing operation P3, which makes it possible to eliminate the lack of homogeneity, in particular that caused by the oxygen depletion steps 5, but also that generally found in a fuel cell. Inversion is also beneficial for the hydration step 2 and the stabilisation step 4. Indeed, given that an oxygen concentration gradient still exists in the cathodic compartment, as explained above, carrying out the stabilisation step 4 before and after the reversing operation P3 also makes it possible to obtain more uniform membrane hydration and more uniform oxidation/reduction of impurities.

In addition, the running-in time of the running-in process is advantageously short, thanks to a sequence of steps effective in reducing and then oxidising the impurities in the catalytic layers, and in particular thanks to the sequence of hydration 2 and oxygen depletion 5 steps.

In addition, dihydrogen consumption is kept under control throughout the running-in process, thanks in particular to the relatively low anode stoichiometric coefficient and the short total time spent in high-current phases, which consume more reactants. This means that the running-in process uses less dihydrogen, which is advantageous given that dihydrogen is generally an expensive gas.

The running-in protocol helps to achieve a catalytic layer morphology that is unattainable with a protocol that does not involve oxygen depletion or gas inversion. The morphology of the catalytic layer and membrane obtained with this process makes it possible to achieve levels of cell efficiency and durability that are unattainable with protocols that do not involve oxygen depletion or gas inversion. This favourable morphology corresponds in particular to a larger total active surface area of platinum, and is promoted mainly by the oxygen depletion step 5 at the cathode.

Finally, the running-in method is particularly easy to set up. It does not require any specific additional components, as it is sufficient to apply a current cycle and control the arrival of the reactants, particularly during the oxygen depletion steps and during the reversing operation P3, to carry out the entire running-in process. It is therefore economical to install.

In the present description, the main focus has been on the phenomena that enable the performance of the cathodic catalytic layer 24 to be improved, by increasing the number of active sites, by increasing its porosity and by the desorption of impurities, whereas the improvement of the performance of the anodic catalytic layer 22 has been little discussed. In practice, it is known that it is easier to achieve good performance from the anodic catalytic layer than from the cathodic catalytic layer, for several reasons. Firstly, as the anodic compartment is generally supplied with pure gas, in particular dihydrogen, it is less exposed to pollutants than the cathodic compartment, which is generally supplied with air that can contain numerous pollutants. In addition, the cathodic catalytic layer is thicker and comprises more platinum particles than the anodic catalytic layer, making it take longer to increase the number of active sites and desorb impurities. Finally, oxygen tends to be deposited on the cathodic catalytic layer, forming platinum oxides, which need to be reduced during the running-in process, whereas this does not occur in the anodic catalytic layer. In this way, the performance improvement targets are more easily achieved for the anodic catalytic layer than for the cathodic catalytic layer, which means that when the cathodic catalytic layer has achieved a satisfactory level of performance, the same necessarily applies to the anodic catalytic layer.

It should be noted that the notions of high value, low value and minimum value, used in the present description in relation to current density, are arbitrary, and are only understood in relation to each other, in the context of the running-in process described herein, and without any link to the corresponding actual values of current density in a particular application. In this description, the high value is strictly greater than the low value, and the minimum value is less than or equal to the low value. The high and minimum values are therefore defined in relation to the low value. Alternatively, the low value is designated as the first predetermined value, the minimum value is designated as the second predetermined value and the high value is designated as the third predetermined value.

In a variant of the invention not shown, the high, low and minimum values of the first running-in phase P2 differ from the high, low and minimum values of the second running-in phase P4. For example, the high, low and minimum values of the second running-in phase P4 are higher or lower than the high, low and minimum values of the first running-in phase P2, in order to take account of changes in the performance of the fuel cell 10 during the running-in process. Such a change in these current density values can be determined to enable the same cathodic potential levels to be reached for the different steps and/or the different phases, in order to generate the desired levels of oxidation, particularly for low current density values, and to generate the desired levels of reduction, particularly for high current density values, if possible identical throughout the activation cycles, depending on the evolution of the characteristics of the fuel cell during activation.

In an unrepresented variant of the invention, the running-in process does not include the initialisation phase P1. In such a variant, the fuel cell 10 is initialised, for example, at the end of its assembly, before it is installed on the activation bench. It is also possible not to provide an initialisation phase P1, and to provide that the first cycle of the first running-in phase P2 includes a current density increase step 1, which is preferably long enough not to cause damage to the fuel cell.

In an unrepresented variant of the invention, the running-in process does not include the control phase P5. In such a variant, the stability of the cell voltage may be assessed by another means, or it may not be assessed until the fuel cell is put into service.

In an unrepresented variant of the invention, the running-in phases P2 and P4 do not comprise steps 1, 2 and 3. In this variant, the running-in phases therefore only include the stabilisation 4 and oxygen depletion 5 steps. This variant has the advantage of minimising the amount of dihydrogen consumed by the running-in process, as the fuel cell is never constrained by the electrical load to a high current density leading to high consumption of reactants. However, in this variant, the running-in process takes longer. In particular, the running-in phases P2 and P4 comprise a greater number of cycles. Without the hydration steps 2, hydration of the proton exchange membrane 20 is still achieved by the oxygen depletion steps 5, but requires a longer running-in time.

In an unrepresented variant of the invention, the tightness of the stack of cells 12 obtained by means of the end plates is monitored throughout the running-in process, and adjusted so as to maintain a constant tightness of the stack of cells, making it possible to take account of any variations in cell dimensions that may occur during running-in. The hydration of the proton exchange membrane 20 and the physico-chemical modification of the catalytic layers 22 and 24 can lead to variations in the thickness of these elements during the running-in process.

In a non-represented variant of the invention, during the hydration steps 2 of the running-in phases P2 and P4, the temperature within the cells 12 is increased to 100° C., either during these steps in their entirety, or for a short time during these steps, making it possible to avoid any re-adsorption of impurities and pollutants in the catalytic layers 22 and 24. By increasing the relative humidity of the reactive gases, this temperature increase prevents flooding of the proton exchange membrane.

In the example, the predefined threshold voltage is constant throughout the running-in process, i.e. it is identical for all the oxygen depletion steps 5 of the running-in phases P2 and P4. In a non-representative variant of the invention, slight variations in the predefined threshold voltage may be provided for during the running-in process, for example by being slightly higher or lower during the second running-in phase P4 than during the first running-in phase P2. However, these variations are small enough for the predefined threshold voltage of the first running-in phase P2 to be substantially equal to the predefined threshold voltage of the second running-in phase P4.

A particularly advantageous mode of the invention corresponds to a process for running-in a fuel cell 10, the fuel cell comprising a stack of cells 12, each cell comprising a proton exchange membrane 20 arranged between two bipolar plates 16, each bipolar plate 16 delimiting, in said cell, with the proton exchange membrane 20, a reactive compartment, each cell thus comprising a cathodic compartment in which a cathodic catalytic layer 24 is arranged, and an anodic compartment in which an anodic catalytic layer 22 is arranged.

The fuel cell comprises a dihydrogen inlet 28 supplying the anodic compartment of each cell with dihydrogen, and a dihydrogen outlet 30 discharging the dihydrogen from each cell. The fuel cell comprises an air inlet 32 supplying air to the cathodic compartment of each cell 12, and an air outlet 34 exhausting air from each cell 12.

The running-in process according to this particularly advantageous mode of the invention comprises at least, in this order, the following steps:
a first running-in phase P2, comprising at least, in this order, the following steps:
a stabilisation step 4 of the fuel cell 10, during which the current density produced by the fuel cell is kept constant at a low value for a predetermined period of time, and
an oxygen depletion step 5 of the fuel cell, during which the current density produced by the fuel cell is kept constant at a minimum value, less than or equal to the low value, and during which the air supply to the fuel cell via the air inlet 32 is at least partially cut off, being set so as to obtain a cathodic stoichiometric coefficient strictly less than 1, preferably less than or equal to 0.9, the oxygen depletion step of the first running-in phase ending when the cell voltage of the fuel cell 10 reaches a predefined threshold voltage,
an operation of reversing the direction of the hydrogen and air flows P3, in which the dihydrogen inlet 28 and the dihydrogen outlet 30 are reversed and in which the air inlet 32 and the air outlet 34 are reversed, and
a second running-in phase P4, comprising at least, in this order, the following steps:
a stabilisation step 4 of the fuel cell 10, during which the current density produced by the fuel cell is kept constant at a low value for a predetermined period of time, and a step of oxygen depletion 5 of the fuel cell, during which the current density produced by the fuel cell is kept constant at a minimum value, less than or equal to the low value of the second running-in phase, and during which the air supply to the fuel cell through the air inlet 32 is at least partially cut off, being adjusted so as to obtain a cathodic stoichiometric coefficient strictly less than 1, preferably less than or equal to 0.9, the oxygen depletion step of the second running-in phase ending when the cell voltage of the fuel cell 10 reaches a predefined threshold voltage.

In addition, the steps of the first running-in phase P2 are carried out until a first stop condition is reached, and the steps of the second running-in phase P4 are carried out until a second stop condition is reached.

Any feature described for one embodiment or variant in the foregoing may be implemented for the other embodiments and variants described above, insofar as technically feasible.

The method for running in a fuel cell of the PEMFC type comprises at least a first running-in phase (P2), then an operation of reversing the direction of the hydrogen and air flows (P3), then a second running-in phase (P4). The running-in phases each comprise a fuel cell stabilisation step (4) in which the current density produced by the cell is kept constant at a low value for a given period, then an oxygen depletion step (5), during which the current density is kept constant at a minimum value, less than or equal to the low value, and during which the air supply is at least partially cut off, being adjusted so as to obtain a cathodic stoichiometric coefficient strictly less than 1. The oxygen depletion steps of the first and second run-in phases end when the cell voltage of the fuel cell reaches a predefined threshold voltage.

1-15. (canceled)

16. A method for running in a fuel cell, the fuel cell comprising a stack of cells, each cell including a proton exchange membrane placed between two bipolar plates, each bipolar plate delimiting, in the said cell, with the proton exchange membrane, a reactive compartment, each cell thus comprising a cathodic compartment in which a cathodic catalytic layer is arranged, and an anodic compartment in which an anodic catalytic layer is arranged,
the fuel cell comprising a dihydrogen inlet supplying hydrogen to the anodic compartment of each cell, and a dihydrogen outlet discharging hydrogen from each cell,
the fuel cell comprising an air inlet supplying air to the cathodic compartment of each cell, and an air outlet exhausting air from each cell,
wherein the running-in process comprises at least, in this order, the following phases:
a first running-in phase, comprising at least one oxygen depletion step of the fuel cell, during which the current density produced by the fuel cell is kept constant at a minimum value, and during which the air supply to the fuel cell via the air inlet is at least partially cut off so as to cause a gradual decrease in the cell voltage, the oxygen depletion step of the first running-in phase ending when the cell voltage of the fuel cell reaches a predefined threshold voltage,
an operation of reversing the direction of the hydrogen and air flows, in which the dihydrogen inlet and the dihydrogen outlet are reversed and in which the air inlet and the air outlet are reversed, and
a second running-in phase, comprising at least one step of oxygen depletion of the fuel cell, during which the current density produced by the fuel cell is kept constant at a minimum value, and during which the air supply to the fuel cell through the air inlet is at least partially cut off, so as to cause a progressive decrease in the cell voltage, the oxygen depletion step of the second running-in phase ending when the cell voltage of the fuel cell reaches a predefined threshold voltage,
in which said at least one step of the first running-in phase is carried out until a first stop condition is reached,
and in which said at least one step of the second running-in phase is carried out until a second stop condition is reached.

17. A method for running-in a fuel cell according to claim 16, in which the first running-in phase also includes, prior to the oxygen depletion step, a stabilisation step of the fuel cell, during which the current density produced by the fuel cell is kept constant at a low value for a predetermined period of time, the low value of the first running-in phase being greater than or equal to the minimum value, and/or in which the second running-in phase also includes, prior to the oxygen depletion step, a stabilisation step of the fuel cell, during which the current density produced by the fuel cell is kept constant at a low value for a predetermined period of time, the low value of the second running-in phase being greater than or equal to the minimum value.

18. A method for running in a fuel cell according to claim 16, in which the minimum value of the first running-in phase and the minimum value of the second running-in phase are between 0.01 A/cm² and 0.3A/cm².

19. A method for running in a fuel cell according to claim 18, in which the minimum value of the first running-in phase and the minimum value of the second running-in phase are equal to 0.02A/cm².

20. A method for running in a fuel cell according to claim 17, in which the minimum value of the first running-in phase and the minimum value of the second running-in phase are between 0.01 A/cm² and 0.3 A/cm² and in which the low value of the first running-in phase and the low value of the second running-in phase are between 0.03 A/cm² and 0.5A/cm².

21. A method for running in a fuel cell according to claim 20, in which the low value of the first running-in phase and the low value of the second running-in phase are equal to 0.3A/cm².

22. A method for running in a fuel cell according to claim 16, in which, during at least one of the said oxygen depletion steps, the air supply to the fuel cell via the air inlet is at least partially cut off by being adjusted so as to obtain a cathode stoichiometric coefficient strictly less than 1.

23. A method for running in a fuel cell according to claim 22, in which said cathode stoichiometric coefficient is less than or equal to 0.9.

24. A method for running in a fuel cell according claim 16, in which the oxygen depletion steps of the first running-in phase and of the second running-in phase end when the cell voltage of the fuel cell reaches a threshold voltage of between 0.1V and 0.4V

25. A method for running in a fuel cell according to claim 24, in which the threshold voltage is equal to 0.2V.

26. A method for running in a fuel cell according to claim 16, in which, during the oxygen depletion steps of the first running-in phase and of the second running-in phase, the air supply to the fuel cell via the air inlet is completely cut off, so as to obtain a cathode stoichiometric coefficient equal to 0.

27. A method for running in a fuel cell according to claim 16, in which, during the oxygen depletion steps of the first running-in phase and of the second running-in phase, the air supply to the fuel cell via the air inlet is controlled so that the cell voltage of the fuel cell decreases monotonically.

28. A method for running in a fuel cell according to claim 16, wherein:
the first running-in phase also comprises the following steps, in this order and carried out before the oxygen depletion step:
a current density increase step, during which the current density produced by the fuel cell is progressively increased from a low value to a high value, the low value being greater than or equal to the minimum value of the first running-in phase,
a hydration step of the fuel cell, during which the current density produced by the fuel cell is kept constant at the high value of the first running-in phase for a predetermined time, so as to hydrate the proton exchange membrane, and
a current density drop step, during which the current density produced by the fuel cell is dropped from the high value of the first running-in phase to the low value of the first running-in phase,
the second running-in phase also comprises the following steps, in this order and carried out before the stabilisation and oxygen depletion steps:
a current density increase step, during which the current density produced by the fuel cell is progressively increased from a low value up to a high value of the second running-in phase, the low value of the second running-in phase being greater than or equal to the minimum value of the second running-in phase,
a hydration step of the fuel cell, during which the current density produced by the fuel cell is kept constant at the high value of the second running-in phase for a predetermined time, so as to hydrate the proton exchange membrane, and
a current density drop step, during which the current density produced by the fuel cell is dropped from the high value of the second running-in phase to the low value of the second running-in phase.

29. A method for running in a fuel cell according to claim 28, in which the high value of the first running-in phase and the high value of the second running-in phase are between 1.5 A/cm² and 3A/cm².

30. A method for running in a fuel cell according to claim 29, in which the high value of the first running-in phase and the high value of the second running-in phase are equal to 1.9A/cm².

31. A method for running-in a fuel cell according to claim 28, wherein:
the steps of increasing current density, hydration, drop in current density, stabilisation and oxygen depletion of the first running-in phase are carried out at least twice in a cyclical manner,
the first stop condition is reached when:
the cell voltage of the fuel cell at the end of the hydration step of the last cycle of the first running-in phase differs from the cell voltage of the fuel cell at the end of the hydration step of the penultimate cycle of the first running-in phase by a value of between 1 mV and 10 mV, or
if appropriate, the cell voltage of the fuel cell at the end of the stabilisation step of the last cycle of the first running-in phase differs from the cell voltage of the fuel cell at the end of the stabilisation step of the penultimate cycle of the first running-in phase by a value of between 1 mV and 10 mV,
the steps of increasing current density, hydration, decreasing current density, stabilisation and oxygen depletion of the second running-in phase are carried out at least twice in a cyclic manner, and
the second stop condition is reached when:
the cell voltage of the fuel cell at the end of the hydration step of the last cycle of the second running-in phase differs from the cell voltage of the fuel cell at the end of the hydration step of the penultimate cycle of the second running-in phase by a value of between 1 mV and 10 mV, or
if appropriate, the cell voltage of the fuel cell at the end of the stabilisation step of the last cycle of the second running-in phase differs from the cell voltage of the fuel cell at the end of the stabilisation step of the penultimate cycle of the second running-in phase by a value of between 1 mV and 10 mV.

32. A method for running in a fuel cell according to claim 28, further comprising an initialization phase, carried out before the first running-in phase, during which the current density produced by the fuel cell is gradually increased from a zero value to the high value of the first running-in phase.

33. A method for running in a fuel cell according to claim 28, further comprising a control phase, carried out after the second running-in phase, during which the current density produced by the fuel cell is maintained at a constant level for a predetermined period.

34. A method for running in a fuel cell according to claim 28, wherein:
during the first running-in phase and the second running-in phase, an anodic stoichiometric coefficient of the fuel cell is equal to a nominal anodic stoichiometric coefficient of the fuel cell, and
during the steps of increasing current density, hydration, current density drop and, if appropriate, stabilisation of the first running-in phase and the second running-in phase, a cathodic stoichiometric coefficient of the fuel cell is greater than a nominal cathodic stoichiometric coefficient of the fuel cell.

35. A method for running in a fuel cell according to claim 16, in which, during the first running-in phase and during the second running-in phase, an electrical load of variable resistance is connected to the terminals of the fuel cell, the electrical load imposing a current production on the fuel cell.
